(19) United States
(12) Patent Application Publication
(10) Pub. No.: US 2018/0270828 A1
(43) Pub. Date: Sep. 20, 2018

(54) RADIO COMMUNICATION SYSTEM, BASE STATION APPARATUS, TERMINAL APPARATUS, AND RADIO COMMUNICATION METHOD

(71) Applicant: FUJITSU LIMITED, Kawasaki-shi (JP)

(72) Inventors: Takeshi AKUTAGAWA, Kawasaki (JP); Akihiro Yamamoto, Kawasaki (JP); Takayoshi Ode, Yokohama (JP)

(73) Assignee: FUJITSU LIMITED, Kawasaki-shi (JP)

(21) Appl. No.: 15/988,931

(22) Filed: May 24, 2018

Related U.S. Application Data
(63) Continuation of application No. PCT/JP2015/083473, filed on Nov. 27, 2015.

(51) Int. Cl. H04W 72/04; H04W 16/14

(52) U.S. Cl. CPC H04W 72/0453; H04W 16/14; H04W 72/0406

(57) ABSTRACT

A radio communication system includes: a first base station apparatus capable of performing radio communication by using a first frequency band requiring license, wherein a scheduler configured to transmit a first control information including a second frequency in a second frequency band without requiring the license to the second base station apparatus, a second transmitter configured to transmit data common to a terminal apparatus by using the second frequency, the first base station apparatus includes: a first transmitter configured to transmit the first control information by using the first frequency to the terminal apparatus, and a receiver configured to receive the first control information transmitted from the first base station apparatus by using the first frequency, and receive the data common to the terminal apparatus transmitted from the second base station apparatus by using the second frequency.

### CROSS-REFERENCE TO RELATED APPLICATION

This application is a continuation application of International Application Number PCT/JP2015/083473 filed on Nov. 27, 2015 and designated the U.S., the entire contents of which are incorporated herein by reference.

### FIELD

The embodiments discussed herein are related to a radio communication system, a base station apparatus, a terminal apparatus and a radio communication method.

### BACKGROUND

At present, a succeeding system to LTE (Long Term Evolution) and LTE Advanced is being studied in the 3GPP (3rd Generation Partnership Project) as a technique for a large capacity, high speed radio communication network system. Such a system is called as 5th Generation mobile communication (5G). In Japan also, a service using CA (Carrier Aggregation), which is one of the LTE-Advanced techniques, has authentically been introduced since 2015, and radio communication with transmission speed exceeding 200 Mbps becomes available.

In CA, the combination of frequencies allocated to a communication carrier or a mobile communication carrier (hereafter referred to as an operator). For example, a Japanese operator owns about five frequency bands, including 800 MHz, 1.7 GHz and so on, to execute CA by the combination of the frequency bands.

However, radio frequencies are allocated to a variety of communication systems including mobile communication, emergency communication such as disaster radio, broadcasting and satellite communication. Therefore, there is a limit in the radio frequency to be allocated to mobile communication.

Meanwhile, a communication amount (or traffic) in mobile communication is being increased year-by-year with the spread of use of smartphone etc. This brings about difficulty in securing frequency to cope with the demand. Therefore, the 3GPP has started to discuss the execution of CA using a frequency which is available without license, such as a 5 GHz band.

As one of the discussions, the standardization of LAA (Licensed Assisted Access using LTE) is under study in the 3GPP. LAA is a technique to execute CA using an unlicensed band and a licensed band.

As to the frequency to be used in radio communication, each country gives a use license to a specific operator in consideration of frequency allocation formulated by ITU-R (International Telecommunication Radio communication Sector) and circumstances in each country. The operator can occupy the frequency, to which the license is given, to perform mobile communication business (or radio communication business). The frequency band to which the license is given and allocated to the operator may be referred to as a licensed band. On the other hand, an unlicensed band is a frequency band which a plurality of operators can use without license. The unlicensed band includes an ISM band (Industry Science Medical band), a 5 GHz band, etc., for example.

Meanwhile, the specification of MBMS (Multimedia Broadcast Multicast Service) has been formed by the 3GPP. MBMS is a system that enables the distribution (or broadcast) of a variety of types of information, such as video, music, weather forecast, etc., to unspecified number of users in 3G (3rd Generation mobile communication) and LTE systems, for example. In MBMS, the variety of types of information are simultaneously distributed (or transmitted) to all terminals in a distribution area, using a common radio channel.

In the LTE service, MBMS is executed using an MBSFN (MBMS Single Frequency Network) transmission scheme. In the MBSFN transmission scheme identical data is transmitted from a plurality of base stations at an identical timing, using an identical frequency, an identical modulation scheme and an identical coding rate, for example. The specification of the MBSFN transmission scheme is specified in W-CDMA (Wideband Code Division Multiple Access) and LTE.

As a service using the MBSFN transmission scheme, there are cases of distributing live video in a stadium such as a soccer field and information including news, weather forecast, sightseeing guide, etc. In particular, in Tokyo Olympics to be held in 2020, the distribution of competition contents from a stadium is currently under study. For example, in athletics, gymnastics, etc., a plurality of competitions are simultaneously carried out in parallel at one stadium, and each user can select and view one of a plurality of a plurality of live videos through the MBSFN transmission.

As a technique related to radio communication, there is the following, for example. Namely, to the primary carrier of a spectrum having received license, the bandwidth of LTE communication is expanded by the component carrier of a spectrum not requiring the license, so that the communication link of an IEEE 802.11n system is supported by the spectrum not requiring the license. According to the above technique, it is urged that a wireless remote communication apparatus can be communicated through a band, not requiring the license, and a band receiving the license, for example.

Also, there is a technique for a radio base station to transmit in a primary cell the control information of dynamic TDD used in a secondary cell. According to the above technique, it is urged that, based on TDD-FDD CA as a premise, dynamic TDD can be achieved without dependent on a TDD UL-DL configuration, for example.

### CITATION LIST

### Patent Literature

Patent literature 1: Japanese National Publication of International Patent Application No.2014-500685.

Patent literature 2: Japanese Laid-open Patent Publication No.2015-133642. NON-PATENT LITERATURE

Non-patent literature 1: 3GPP TS 36.211 V10.7.0 (2013-02). Non-patent literature 2: 3GPP TS 36.300 V10.10.0 (2013-06).

However, when the MBSFN transmission is executed using the frequency of the licensed band owned by the operator, another frequency in the licensed band is restricted by the MBSFN transmission. The other frequency in the licensed band is a frequency to deal with the increase in traffic. Therefore, the MBSFN transmission may cause a problem of the lack of frequency.

Further, when the MBSFN transmission is performed by a plurality of operators, the MBSFN transmission is performed using different licensed bands among the operators. This disables the effective use of frequencies among the operators at the MBSFN transmission, impeding effective frequency utilization. In this case, the transmission of an identical content may be performed in duplication from a base station of each operator to a subscriber terminal of each operator. Oppositely, there is also a case that a subscriber terminal of a specific operator may fail to receive a content transmitted from a base station of another operator. For example, a terminal subscribing to an operator of another country than Japan may fail to receive a content transmitted from a base station in Japan.

### SUMMARY

According to an aspect of the embodiments, a radio communication system includes: a first base station apparatus which is capable of performing radio communication by using a first frequency band requiring license; a second base station apparatus; a radio channel control apparatus; and a terminal apparatus, wherein the radio channel control apparatus includes: a scheduler configured to transmit a first control information including a second frequency in a second frequency band without requiring the license and a first transmission timing to the second base station apparatus, the second base station apparatus includes: a second transmitter configured to transmit data common to the terminal apparatus by using the second frequency at the first transmission timing, the first base station apparatus includes: a first transmitter configured to transmit the first control information by using the first frequency to the terminal apparatus, and the terminal apparatus includes: a receiver configured to receive the first control information transmitted from the first base station apparatus by using the first frequency, and receive the data common to the terminal apparatus transmitted from the second base station apparatus by using the second frequency at the first transmission timing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a radio communication system.

FIG. 2 is a diagram illustrating a configuration example of a radio communication system.

FIG. 3 is a diagram illustrating an example of LAA.

FIG. 4 is a diagram illustrating a configuration example of a radio communication system.

FIG. 5 is a diagram illustrating a configuration example of an eMBMS system.

FIG. 6A and FIG. 6B are diagrams illustrating a configuration example of an eMBMS system.

FIG. 7 is a diagram illustrating a configuration example of MCE.

FIG. 8 is a diagram illustrating a configuration example of a base station apparatus.

FIG. 9 is a diagram illustrating a configuration example of a base station apparatus.

FIG. 10 is a diagram illustrating a relation example among each channel.

FIG. 11 is a diagram illustrating a configuration example of a terminal apparatus.

FIG. 12 is a sequence diagram illustrating an operation example.

FIG. 13A through FIG. 13D are diagrams illustrating the examples of radio resource allocation.

FIG. 14 is a diagram illustrating a configuration example of a radio communication system.

FIG. 15 is a diagram illustrating a hardware configuration example of a base station apparatus.

FIG. 16 is a diagram illustrating a hardware configuration example of a terminal apparatus.

FIG. 17 is a diagram illustrating a hardware configuration example of MCE.

### DESCRIPTION OF EMBODIMENTS

Hereinafter, the present embodiments will be described in detail by reference to the drawings. The problems and the embodiments in the present description are examples which are not intended to restrict the scope of rights of the present application. In particular, each technique in the present application is applicable as long as being technically equivalent, if the representation of description is different, without restriction of the scope of rights.

Further, as to the terms used in the present description and the technical contents described in the present description, it is possible to appropriately use the terms and the technical contents described in the specifications of the 3GPP etc. as standards related to communication. As the examples of such specification, there are non-patent literatures 1, 2 mentioned earlier, and so on.

### First Embodiment

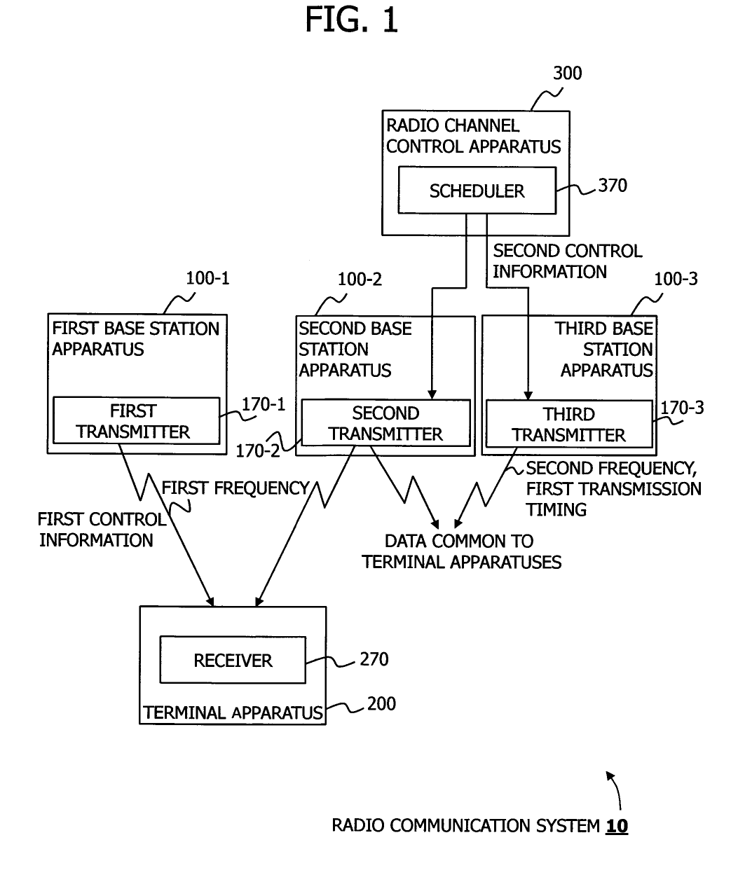

FIG. 1 is a diagram illustrating a configuration example of a radio communication system 10 according to a first embodiment. The radio communication system 10 includes a first base station apparatus 100-1, a second and a third base station apparatus 100-2, 100-3, a terminal apparatus 200 and a radio channel control apparatus 300.

The first base station apparatus 100-1 can perform radio communication using a first frequency band allocated to a first communication carrier. The first base station apparatus 100-1 includes a first transmitter 170-1.

The first transmitter 170-1 transmits first control information to the terminal apparatus 200 using a first frequency in the first frequency band.

The second and third base station apparatuses 100-2, 100-3 receive second control information transmitted from the radio channel control apparatus 300. The second base station apparatus 100-2 includes a second transmitter 170-2, and the third base station apparatus 100-3 includes a third transmitter 170-3.

The second transmitter 170-2 transmits, based on the second control information, data common to each terminal apparatus at a first transmission timing, using a second frequency in a second frequency band which is available by a first and a second communication carrier.

Also, based on the second control information, the third transmitter 170-3 transmits the data common to each terminal apparatus at the first transmission timing, using the second frequency in the second frequency band.

The terminal apparatus 200 includes a receiver unit 270. The receiver unit 270 receives the first control information transmitted from the first base station apparatus 100-1, by using the first frequency. Also, based on the first control information, the receiver unit 270 is connected to the second base station apparatus 100-2, so as to receive the data common to each terminal apparatus and transmitted from the second base station apparatus 100-2, at the first transmission timing by using the second frequency.

The radio channel control apparatus 300 includes a scheduler 370. The scheduler 370 transmits, to the second and third base station apparatuses 100-2, 100-3, the second control information which includes the second frequency in the second frequency band and the first transmission timing.

As such, in the present first embodiment, the second and third base station apparatuses 100-2, 100-3 transmit the data common to each terminal apparatus, by using the second frequency in the second frequency band which is available in the first and second communication carriers. The second and third base station apparatuses 100-2, 100-3 are configured to transmit the data common to each terminal apparatus using a common frequency, for example, so that can obtain effective frequency utilization in comparison with a case of transmitting the data common to each terminal apparatus using different frequencies. Accordingly, it is possible to achieve effective radio resource use.

Further, for example, when the terminal apparatus 200 is a terminal apparatus which becomes available by contracting with the first communication carrier, the terminal apparatus 200 receives the first control information transmitted from the first base station apparatus 100-1 using the first frequency of the first frequency band which is allocated to the first communication carrier. Based on the first control information, the terminal apparatus 200 is connected to the second base station apparatus 100-2 to receive the data common to each terminal apparatus, transmitted from the second base station apparatus 100-2. Accordingly, the terminal apparatus 200, if contracting with the first communication carrier, can receive the data common to each terminal apparatus from the second base station apparatus 100-2.

In this case, the second and third base station apparatuses 100-2, 100-3 transmit the data common to each terminal apparatus at the first transmission timing, using the second frequency of the second frequency band which is available by the first and second communication carriers. Because the second frequency band is a frequency band which is available by a plurality of communication carriers, the second frequency band is an unlicensed band, for example. Also, the data transmitted from the second and third base station apparatuses 100-2, 100-3 are transmitted as the common (or identical) data at the common (or identical) first transmission timing, using the common (or identical) second frequency. This signifies that the second and third base station apparatuses 100-2, 100-3 perform the MBSFN transmission, for example. Accordingly, the second and third base station apparatuses 100-2, 100-3 perform the MBSFN transmission, using the unlicensed band, for example.

Therefore, the terminal apparatus 200, even if contracting with a specific operator (for example, the first communication carrier), can receive the data from the second base station apparatus 100-2 which is performing the MBSFN transmission using the unlicensed band.

### Second Embodiment

Next, a second embodiment will be described. First, terms described in the present second embodiment will be described.

<Description of Terms>

MBMS (Multimedia Broadcast Multicast Service) is, for example, a service of simultaneously distributing (or transmitting) a variety of information including video, music, etc., using a common radio channel.

MBSFN (MBMS Single Frequency Network) transmission scheme is, for example, a scheme of executing MBMS data transmission in an LTE system. The MBSFN transmission scheme is, for example, a scheme of transmitting identical MBMS data simultaneously (or at an identical timing) from a plurality of base stations by an identical modulation scheme and an identical coding rate, using an identical frequency.

An area in which the MBSFN transmission scheme is executed may be referred to as an MBSFN area, for example. To each MBSFN area, an MBSFN ID (Identification) is allocated as identification information to identify from other MBSFN areas, for example. The allocation of the MBSFN ID may be allocated fixedly when an operator performs mobile communication business, or may be allocated dynamically by an MME (Mobility Management Entity), an MCE (Multi-cell/multicast Coordination Entity), etc.

Licensed Band is, for example, a frequency band for which use license is given to a specific operator in each country. Licensed Band is a frequency band allocated to a specific operator, for example. The specific operator can perform mobile communication business by occupying the licensed band. Licensed Band may be referred to as a frequency band requiring license, for example.

Unlicensed Band is, for example, a frequency band which is available by a plurality of operators etc., without a use license given to a specific operator. Unlicensed Band may be referred to as a frequency band not requiring the license, for example. Unlicensed Band, which is specified in Japan for specific small-power communication, for example, is freely available as long as regulations, such as an upper limit of transmission power, an upper limit of continuous transmission time and the confirmation of no frequency being used before transmission, are obeyed.

CA (Carrier Aggregation) signifies the execution of radio communication using a plurality of frequencies at the same time, for example. Here, one frequency has, for example, a specific bandwidth and may be used in the same meaning as a component carrier (which may hereafter be referred to as “CC”). Therefore, CA signifies the execution of radio communication using a plurality of CC.

LAA (Licensed Assisted access using LTE) is a scheme for executing CA through an unlicensed band and a licensed band to perform radio communication using the LTE system, for example.

Distribution is used to signify data distribution from a base station apparatus to a terminal apparatus, for example. Further, transmission may be used as a meaning of conveying data, for example. In the present description, distribution and transmission are used in substantially the same signification. Further, transmission includes transmission (sending) and receiving, for example. Therefore, in some cases, transmission may be different from transmission (sending), for example.

Notification or Broadcast signifies, for example, information distribution from a base station apparatus to all terminal apparatuses in a distribution area. Notification or Broadcast may be referred to as broadcast, for example. Also, information distribution from a base station apparatus to all terminal apparatuses which are subordinate to a specific group may be referred to as Multicast.

Mobile Communication Carrier or Communication Carrier signifies an operator which provides a communication service. Mobile Communication Carrier or Communication Carrier may be referred to as operator, for example.

Cell is a service area which is configured by the use of one frequency, for example. In this case, because of one frequency, Cell and frequency may be used as the same meaning. Further, Cell may be a service area formed of one radio base station apparatus (which may hereafter be referred to as “base station”), or may be the combination of the service area with the base station apparatus.

Frequency Band has, for example, a specific bandwidth. Therefore, Frequency Band may be referred to as frequency, for example. Further, Frequency Band has a constant bandwidth centering a center frequency.

The aforementioned terms are examples. As such terms, terms and the meaning thereof which are described in the 3GPP specifications, specifying communication standards, etc. may be used, for example.

<Configuration Example of Radio Communication System>

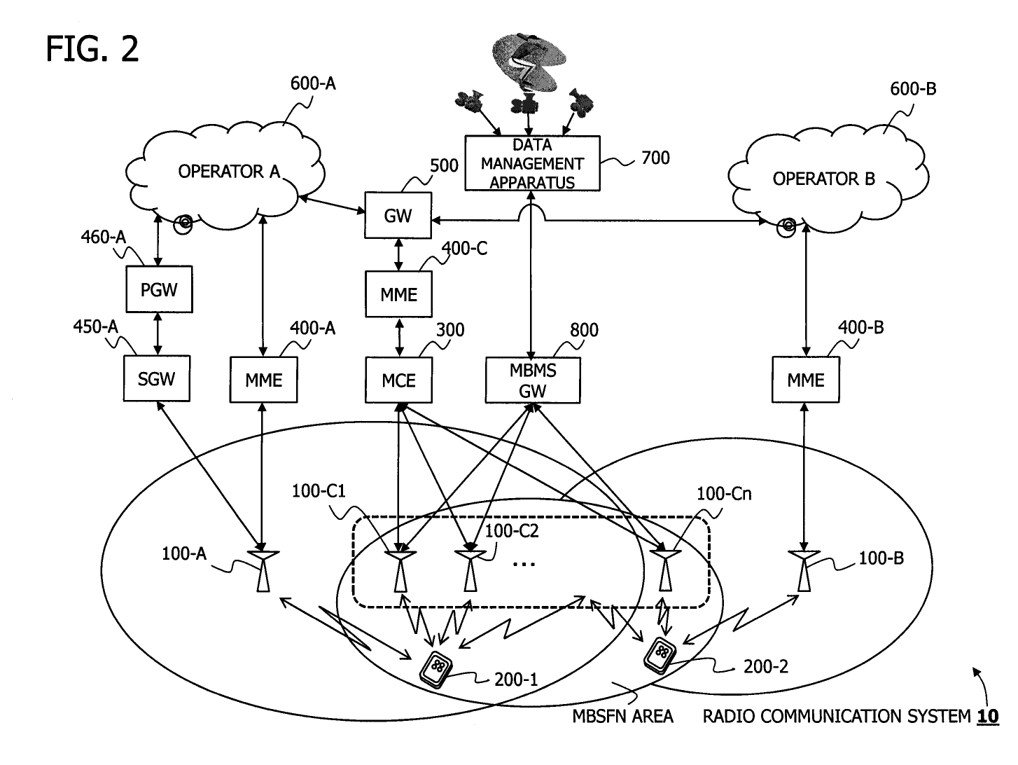

Next, a description will be given on a configuration example of the radio communication system according to the present second embodiment. FIG. 2 is a diagram illustrating the configuration example of the radio communication system 10.

The radio communication system 10 includes a base station apparatus 100-A, an MME 400-A, an SGW (Serving Gateway) 450-A, a PGW (PDN (Packet Data Network) Gateway) 460-A and a network of operator A 600-A. The base station apparatus 100-A, the MME 400-A, the SGW 450-A, the PGW 460-A and the network of operator A 600-A are apparatuses which are operated and managed by the operator A, for example.

Further, the radio communication system 10 includes a base station 100-B, an MME 400-B and a network of operator B 600-B. The base station 100-B, the MME 400-B and the network of operator B 600-B are apparatuses which are operated and managed by the operator B, for example.

Moreover, the radio communication system 10 includes a plurality of base stations 100-C1, . . . , 100-Cn (n is an integer of 2 or more), an MCE 300, an MME 400-C, a GW (Gateway) 500, a data management apparatus 700 and an MBMS GW (MBMS Gateway) 800. The plurality of base stations 100-C1, . . . , 100-Cn, the MCE 300, the MME 400-C, the GW 500, the data management apparatus 700 and the MBMS GW 800 may be apparatuses on the operator A side, apparatuses on the operator B side, or apparatuses of another operator. Alternatively, the above apparatuses may be operated, managed or used by a plurality of operators in a cooperative manner.

Further, the radio communication system 10 includes terminal apparatuses (which may hereafter be referred to as “terminals”) 200-1, 200-2.

Here, the first base station apparatus 100-1 in the first embodiment corresponds to the base station 100-A, for example. Also, the second and third base station apparatuses 100-2, 100-3 in the first embodiment correspond to the base stations 100-C1, 100-C2, for example. Further, the terminal apparatus 200 in the first embodiment corresponds to the terminal 200-1, for example. Further, the radio channel control apparatus 300 in the first embodiment corresponds to the MCE 300, for example.

The base station 100-A is a radio communication apparatus which performs radio communication with the terminals 200-1, 200-2 located in the service area of the self-station, using a licensed band allocated to the operator A. Also, the base station 100-B performs radio communication with the terminals 200-1, 200-2 located in the service area of the self-station, using each licensed band allocated to the operator B.

Meanwhile, the plurality of base stations 100-C1, . . . , 100-Cn perform radio communication with the terminals 200-1, 200-2 using each unlicensed band. The unlicensed band is a frequency which is available in common by a plurality of operators without depending on the operators, for example. Therefore, the plurality of base stations 100-C1, . . . , 100-Cn which use the unlicensed band are also base stations available in common by the plurality of operators.

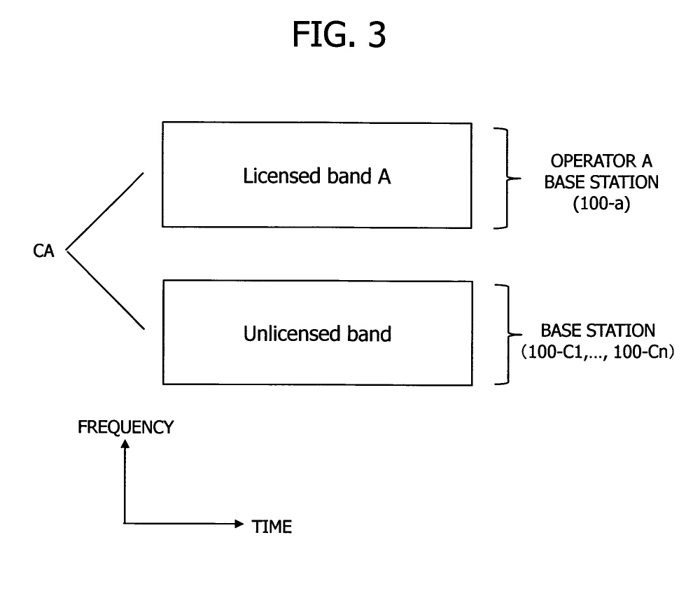

Further, LAA is applied among the base station 100-A and the plurality of base stations 100-C1, . . . , 100-Cn. Thus, CA is executed among the base station 100-A and the plurality of base stations 100-C1, . . . , 100-Cn, using the licensed band and the unlicensed band. FIG. 3 illustrates an example that CA is executed among the base station 100-A and the plurality of base stations 100-C1, . . . , 100-Cn.

Referring back to FIG. 2, LAA is applied among the base station 100-B and the plurality of base stations 100-C1, . . . , 100-Cn. Thus, CA is executed among the base station 100-B and the plurality of base stations 100-C1, . . . , 1, using the licensed band and the unlicensed band.

In this case, the terminal 200-1, after setting a radio channel to connect to the base station 100-A, sets radio channels to connect to the plurality of base stations 100-C1, . . . , 100-Cn, so that LAA is executed. Also, the terminal 200-2, after setting a radio channel to connect to the base station 100-B, sets radio channels to connect to the plurality of base stations 100-C1, . . . , 100-Cn, so that LAA is executed.

The plurality of base stations 100-C1, . . . , 100-Cn perform MBSFN transmission using the unlicensed band. The plurality of base stations 100-C1, . . . , 100-Cn are connected to the MBMS GW 800 to receive MBMS data, transmitted from the MBMS GW 800, to perform MBSFN transmission on the received MBMS data.

Each the terminal 200-1, 200-2 is, for example, a radio communication apparatus such as feature phone, smartphone, tablet terminal, personal computer and game apparatus. The terminal 200-1 is a subscriber terminal on the operator A side which becomes available after a user contracts with the operator A. On the other hand, the terminal 200-2 is a subscriber terminal on the operator B side which becomes available after a user contracts with the operator B. Any terminal 200-1, 200-2 receives the MBMS data from the plurality of base stations 100-C1, . . . , 100-Cn, so that may receive the MBMS distribution service. In this case, the terminal 200-1, 200-2 receives MBSFN control information from the plurality of base stations 100-C1, . . . , 100-Cn, so as to receive the MBMS data on the basis of the received MBSFN control information. The MBSFN control information includes control information such as a radio resource allocated to each the terminal 200-1, 200-2, a modulation scheme, a coding rate, etc., for example.

Additionally, the base stations 100-A, 100-B, 100-C1, . . . , 100-Cn can perform bidirectional communication with the terminals 200-1, 200-2. Namely, communication can be performed both in a direction from the base stations 100-A, 100-B, 100-C1, . . . , 100-Cn to the terminals 200-1, 200-2 (hereafter, a “downlink direction”) and in a direction from the terminals 200-1, 200-2 to the base stations 100-A, 100-B, 100-C1, . . . , 100-Cn (hereafter, an “uplink direction”).

In the radio communication system 10 illustrated in FIG. 2, one base station 100-A on the operator A side and one base station 100-B on the operator B side are depicted, respectively. However, a plurality of base stations may be installed in each operator. Also, as to the terminals 200-1, 200-2, one, three or more may be existent in the radio communication system 10.

The MCE 300 controls (or determines or selects) an MBSFN ID, an M-RANTI (MBMS Radio Network Temporary ID), a use frequency, a use modulation scheme, a use coding rate, a transmission timing, etc. at the execution of MBSFN.

Further, the MCE 300 controls (or determines or selects) a data amount of MBMS data to be transmitted from the base stations 100-A, 100-B, 100-C1, . . . , 100-Cn. Such control functions performed in the MCE 300 may be referred to as scheduling.

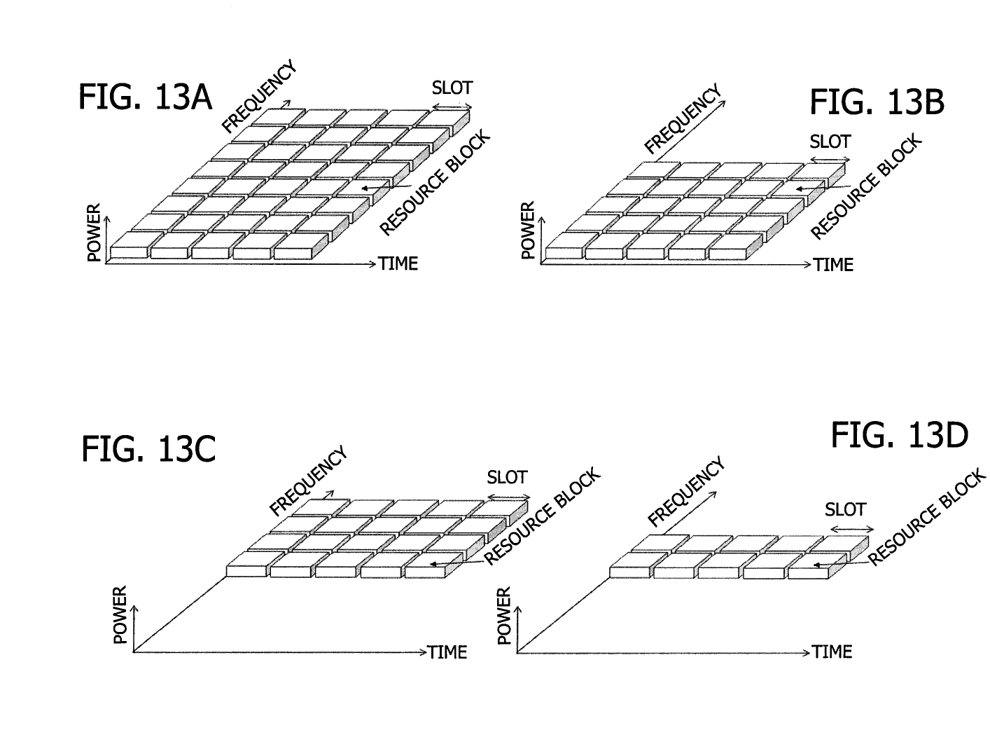

FIGS. 13(A) through 13(D) illustrate the examples of a use frequency and a transmission timing scheduled in the MCE 300. FIGS. 13(A) through 13(D) illustrate examples in which different scheduling is performed user-by-user. The MCE 300 may schedule the use frequency and the transmission timing user-by-user, or may schedule on the basis of each resource block.

The MCE 300 generates MBSFN control information (or second MBSFN control information) which includes the MBSFN ID, the M-RNTI, the use frequency, the transmission timing, etc. determined through the scheduling, to transmit the generated MBSFN control information to the subordinate base stations 100-A, 100-B, 100-C1, . . . , 100-Cn. Further, the MCE 300 generates, for example, a list (which may hereafter be referred to as a “content list”) indicative of an MBMS data content to be transmitted, to transmit the generated content list to the subordinate base stations 100-A2, . . . , 100-B1.

The MMEs 400-A, 400-B, 400-C perform the establishment and the release of a bearer, the position management and the movement control of the terminals 200-1, 200-2, including a handover, etc. Further, the MME 400-C functions, for example, as an upper level apparatus of the MCE 300, so as to control the session of MBMS data and control to establish a bearer to the MBMS data, etc. The session indicates the start and the stop of MBSFN, for example.

The SGW 450-A is a relay apparatus (or gateway apparatus) which relays user data etc. between the base station apparatus 100-A and the PGW 460-A, for example. Further, the SGW 450-A may exchange a control signal between with the MME 400-A.

The PGW 460-A is a relay apparatus (or gateway apparatus) which connects the network of operator A 600-A to the radio communication system 10 to relay user data etc., for example. The PGW 460-A also performs the delivery of an IP address, charge data collection, QoS (Quality of Service) control, etc. to the terminal 200-1, which is a subscriber terminal of the operator A, for example.

The GW 500 is a gateway which connects networks among operators, for example. In the example of FIG. 2, the GW 500 connects the network of operator A 600-A to the network which executes the MBSFN transmission.

The data management apparatus 700 collects data related to a video, imaged by a camera apparatus, and voice, for example, to manage the data as content data. The data management apparatus 700 has a large-capacity storage medium (or memory) including an HDD (Hard Disk Drive) etc. to store the data, and in response to a request from the MBMS GW 800, read out the stored data to transmit to the MBMS GW 800. The data collected and managed by the data management apparatus 700 may be referred to as MBMS data, for example. Additionally, the data management apparatus 700 may be referred to as a BM-SC (Broadcast Multicast-Service Center), for example.

The MBMS GW 800 receives the MBMS data transmitted from the data management apparatus 700 to transmit the received MBMS data to the base stations 100-A2, . . . , 100-B1, which perform the MBSFN transmission, in multicast.

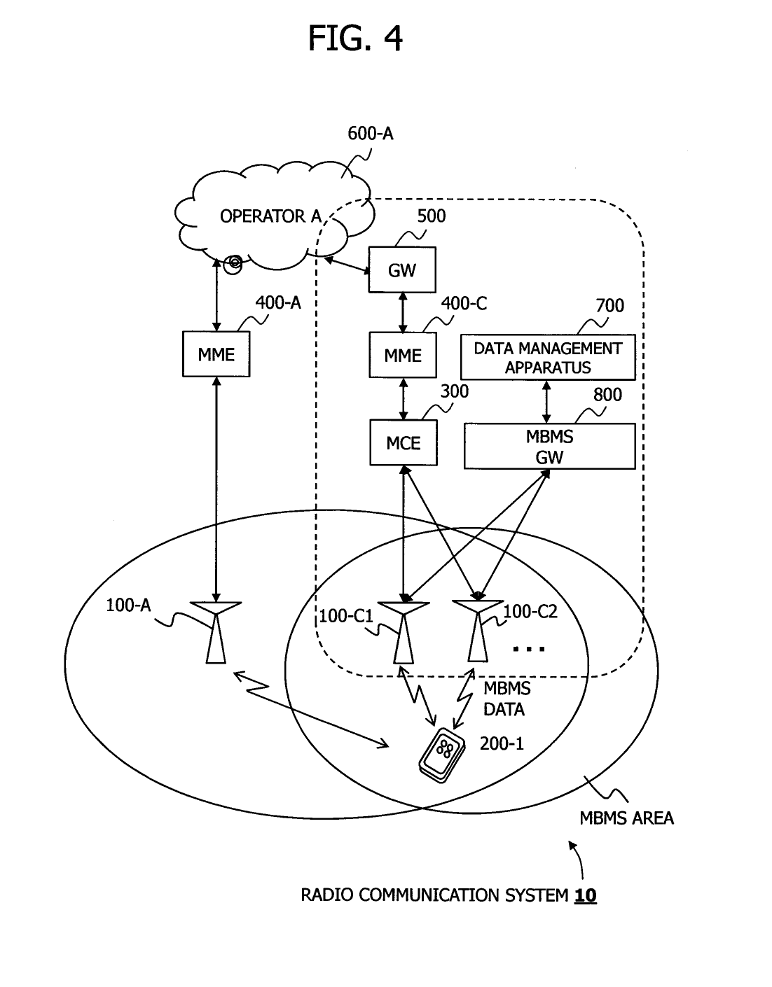

FIG. 4 is a configuration example of the radio communication system 10 obtained by extracting a part of the radio communication system 10 depicted in FIG. 2. In the present second embodiment, the base station 100-A of the operator A transmits control information (or first control information) to the terminal 200-1, using the licensed band allocated to the operator A. Based on the control information, the terminal 200-1 sets a radio channel to connect to each base station 100-C1, . . . , 100-Cn which performs the MBSFN transmission using the unlicensed band. The control information becomes control information for the terminal 200-1 to connect to the base station 100-C1, . . . , 100-Cn. The control information may be referred to as first MBSFN control information, for example.

The terminal 200-1 then receives MBSFN control information (or second control information) from the connected base station 100-C1, . . . , 100-Cn. Based on the MBSFN control information, the terminal 200-1 receives MBMS data (or data common to terminal apparatus) which is distributed from the base station 100-C1, . . . , 100-Cn. The MBSFN control information is also control information for the terminal 200-1 to receive the MBMS data. The MBSFN control information may be referred to as second MBSFN control information, for example.

The first MBSFN control information may include, for example, an MBSFN ID, a frequency a slot number and an SFN (System Frame Number, or radio frame number) used by the plurality of base stations 100-C1, . . . , 100-Cn. The first MBSFN control information is generated in the MCE 300, for example, and transmitted from the base station 100-A through the MME 400-C, the GW 500 and the network of operator A 600-A and the MME 400-A. However, the first MBSFN control information may be generated in the MME 400-C. Or, it may also be possible that a part of information included in the first MBSFN control information is generated in the MCE 300 and the remaining information is generated in the MME 400-C. In this case, information included in the first MBSFN control information may be collected to the MCE 300 and transmitted from the MCE 300 toward the base station 100-A, or may be collected to the MME 400-C and transmitted toward the base station 100-A.

The MBSFN ID, in the example of FIG. 4, comes to identification information to identify an MBSFN area in which each base station 100-C1, . . . , 100-Cn provides an MBMS data distribution service. Or, the MBSFN ID comes to identification information to identify an area in which the base station 100-C1, . . . , 100-Cn transmits the data common to each terminal apparatus at an identical transmission timing, using an identical frequency, for example. Or, the MBSFN ID is also identification information to identify a service which is common to each terminal apparatus and is transmitted in the MBSFN area, for example. The MBSFN ID may be included in both of the first and second MBSFN control information.

Additionally, the second MBSFN control information includes control information which is generated in the MCE 300 and scheduled by the MCE 300, as described above. As the second MBSFN control information, for example, there are the use frequency, the use modulation scheme, the use coding rate, the transmission timing, etc. which are used in the plurality of base stations 100-C1, . . . , 100-Cn for the MBSFN transmission. The use frequency, the use modulation scheme, the use coding rate, the transmission timing, etc. are identical or common among the plurality of base stations 100-C1, . . . , 100-Cn at the execution of the MBSFN transmission, for example.

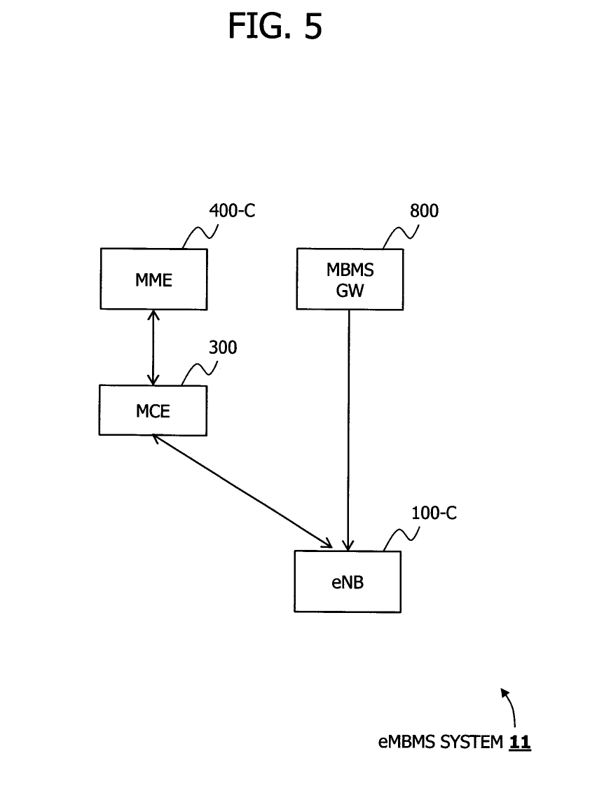

FIG. 5 illustrates a configuration example of an eMBMS (evolved MBMS) system 11. The eMBMS system 11 is, for example, a part of the radio communication system 10 and included in the radio communication system 10.

The eMBMS system 11 includes a base station (eNB (evolved Node B)) 100-C, the MCE 300, the MME 400-C and the MBMS GW 800. The base station 100-C may be one of the base stations 100-C1, . . . , 100-Cn depicted in FIG. 2. Hereinafter, the base stations 100-C1, . . . , 100-Cn may be referred to as base station 100-C.

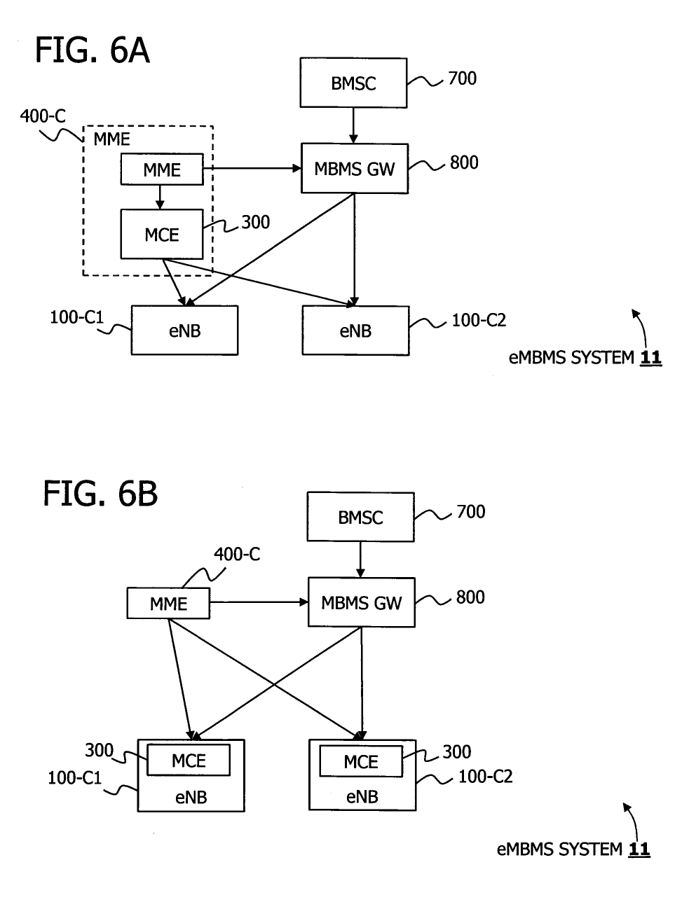

FIGS. 6(A) and 6(B) illustrate other configuration examples of the eMBMS system 11. The MCE 300 may be included in the MME 400-C, as depicted in FIG. 6(A). In this case, the MCE 300 may be actualized as one function of the MME 400-C. Also, the MCE 300 may be included in each base station 100-C1, 100-C2, as depicted in FIG. 6(B). In this case, the MCE 300 may be actualized as one function of each base station 100-C1, 100-C2.

Next, each configuration example of the MCE 300, the base stations 100-A, 100-B, 100-C1, . . . , 100-Cn and the terminals 200-1, 200-2 will be described. Here, since the base stations 100-A, 100-B are of an identical configuration, the description will be given by taking the base station 100-A as an example, in a representative manner. Also, since the base stations 100-C1, . . . , 100-Cn are of an identical configuration, the description will be given as a base station 100-C. Further, since the terminals 200-1, 200-2 are of an identical configuration, the description will be given as the terminal 200.

<MCE Configuration Example>

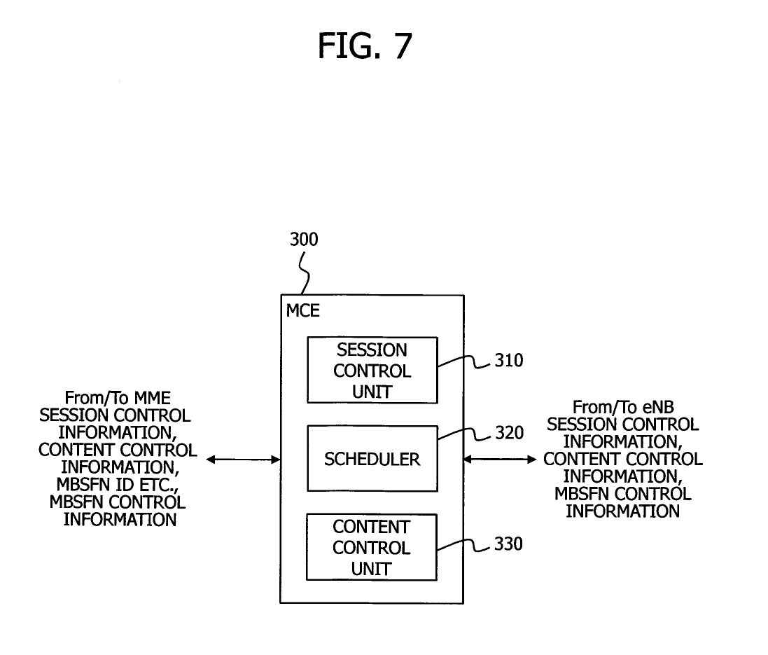

FIG. 7 is a diagram illustrating a configuration example of the MCE 300. The MCE 300 includes a session control unit 310, a scheduler 320 and a content control unit 330.

The session control unit 310 controls, for example, a session for the MBSFN transmission. For example, the session control unit 310 generates session control information to instruct the start and the end of the MBMS data transmission to transmit to the MMEs 400-A, 400-B and the subordinate base station 100. Here, the session signifies to start or stop the MBSFN, for example.

The scheduler 320 selects the frequency, the modulation scheme, the coding rate, the transmission timing, the MBSFN ID, etc. at the execution of the MBSFN transmission, to generate second MBSFN control information including such selected information. The scheduler 320 transmits the generated second MBSFN control information to the subordinate base station 100-C. The information of the use frequency, the use modulation scheme, the use coding rate, the transmission timing, the MBSFN ID, etc. included in the second control information may be stored in advance in an internal memory of the scheduler 320, a memory in the MCE 300, etc. The scheduler 320 may be configured to appropriately access such a memory and read out such information to generate the first MBSFN information.

Additionally, at MBMS data transmission, the base station 100 specifies a transmission timing to transmit MBMS data, using the system frame (or radio frame) number, the sub-frame number and the slot number. The scheduler 320 may transmit to the base station 100-C by including the system frame number, the sub-frame number and the slot number in the second MBSFN control information, as the transmission timing.

Further, for example, the scheduler 320 may select the frequency, the system frame number, the slot number, etc. to be used at the execution of the MBSFN transmission, to generate the first MBSFN control information including such selected information. In this case, the scheduler 320 transmits the generated first MBSFN control information through the MME 400-C etc. to the base stations 100-A, 100-B of each operator.

The content control unit 330 performs, for example, control related to a content to be transmitted from the MBMS GW 800 to the base station 100-C. For example, the content control unit 330 generates a content list and generates content control information including the generated content list, so as to transmit the generated content control information to the base station 100. Also, the content control unit 330 may generate content control information which includes a data amount (or MBMS data amount) of a content to be distributed, so as to transmit the generated content control information to the base station 100-C.

<Base Station Configuration Example>

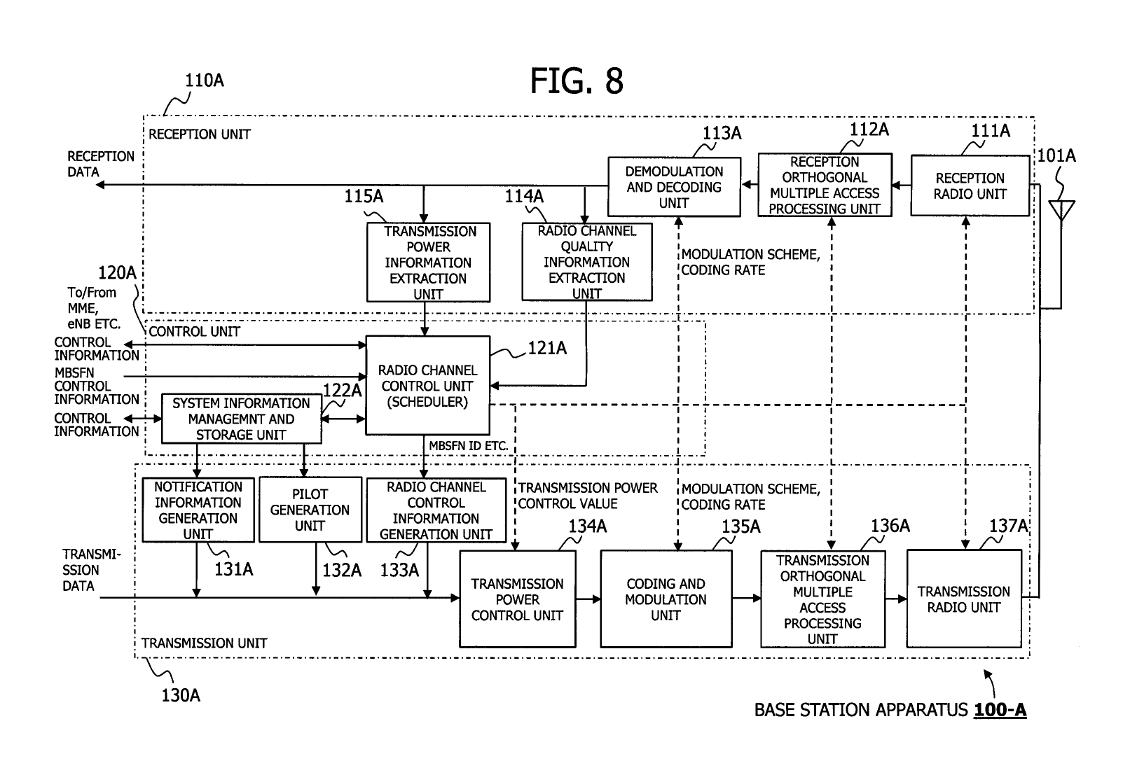

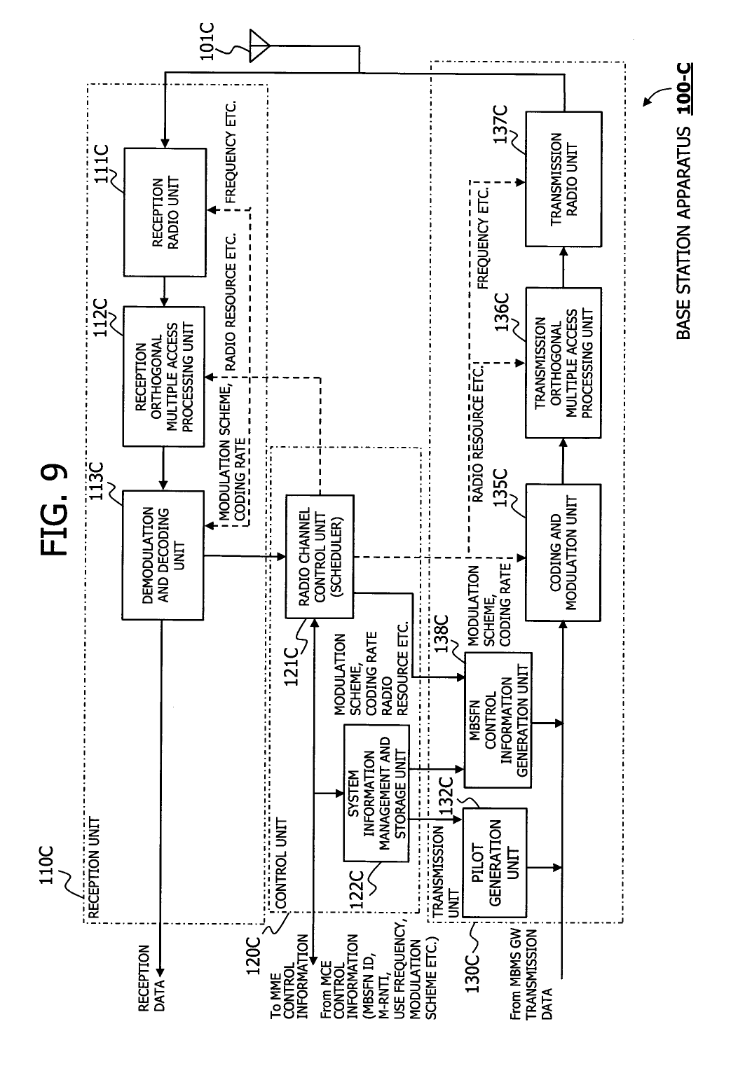

Next, configuration examples of the base stations 100-A, 100-C will be described. FIG. 8 illustrates the configuration example of the base station 100-A, and FIG. 9 illustrates the configuration example of the base station 100-C, respectively. The base station 100-A performs radio communication with the terminal 200-1 using the licensed band, to transmit the first MBSFN control information to the terminal 200-1. Meanwhile, the base station 100-C executes MBSFN transmission using the unlicensed band, to transmit the second MBSFN control information and the MBMS data.

<Configuration Example of Base Station 100-A>

As depicted in FIG. 8, the base station 100-A includes an antenna 101A, a reception unit 110A, a control unit 120A and a transmission unit 130A.

Here, the first transmitter 170-1 in the first embodiment corresponds to the transmission unit 130-A, for example.

The reception unit 110A includes a reception radio unit 111A, a reception orthogonal multiple access processing unit 112A, a demodulation and decoding unit 113A, a radio channel quality information extraction unit 114A and a transmission power information extraction unit 115A.

Also, the control unit 120A includes a radio channel control unit (or a scheduler) 121A and a system information management and storage unit (which may hereafter be referred to as a “system information management unit”) 122A.

Further, the transmission unit 130A includes a notification information generation unit 131A, a pilot generation unit (or a reference signal generation unit) 132A, a radio channel control information generation unit 133A, a transmission power control unit 134A, a coding and modulation unit 135A, a transmission orthogonal multiple access processing unit 136A and a transmission radio unit 137A.

The antenna 101A receives a radio signal transmitted from the terminal 200, and outputs the received radio signal to the reception radio unit 111A. Also, the antenna 101A receives a radio signal being output from the transmission radio unit 137A, and transmits the radio signal to the terminal 200.

The reception radio unit 111A amplifies the radio signal received from the antenna 101A, so as to convert (downconvert) the radio signal in a radio band into a baseband signal in a baseband on the basis of a frequency etc. received from the radio channel control unit 121A. The reception radio unit 111A outputs the converted baseband signal to the reception orthogonal multiple access processing unit 112A.

The reception orthogonal multiple access processing unit 112A performs, on the baseband signal, an A/D (Analog to Digital) conversion processing, a S/P (Serial to Parallel) conversion processing, a FFT (Fast Fourier Transform) processing etc. The reception orthogonal multiple access processing unit 112A then demultiplexes a multiplexed signal according to radio resource information etc. received from the radio channel control unit 121A. The reception orthogonal multiple access processing unit 112A outputs the demultiplexed signal to the demodulation and decoding unit 113A, as a reception signal.

The demodulation and decoding unit 113A executes a demodulation processing and an error correction decoding processing on the reception signal being output from the reception orthogonal multiple access processing unit 112A, according to the modulation scheme and the coding rate which are received from the radio channel control unit 121A. Also, the demodulation and decoding unit 113A generates a scrambling code on the basis of the cell ID, the slot number, etc. which are received from the radio channel control unit 121A, to perform a descrambling processing on the demodulated reception signal, using the generated scrambling code. The demodulation and decoding unit 113A regenerates data etc. transmitted from the terminal 200 through the descrambling processing. The demodulation and decoding unit 113A is a generation unit which generates the scrambling code, and also a processing unit which performs the descrambling processing, for example.

The radio channel quality information extraction unit 114A extracts radio channel quality information from the data etc. being output from the demodulation and decoding unit 113A, so as to output the extracted radio channel quality information to the radio channel control unit 121A.

The transmission power information extraction unit 115A extracts transmission power information from the data etc. being output from the demodulation and decoding unit 113A. The transmission power information is, for example, information related to transmission power when the terminal 200 transmits a radio signal. The transmission power information extraction unit 115A outputs the extracted transmission power information to the radio channel control unit 121A.

The radio channel control unit 121A selects, based on the radio channel quality information and the transmission power information, the radio resource, the modulation scheme, the coding rate, etc. to be used for communication with the terminal 200, for example. Such selection may be referred to as scheduling. The radio channel control unit 121A performs scheduling in both uplink and downlink directions. As to transmission data to be transmitted to the terminal 200, the radio channel control unit 121A may schedule in a manner to transmit using PDSCH (Physical Downlink Shared Channel), and as to reception data received from the terminal 200, the radio channel control unit 121A may schedule in a manner to receive using PUSCH (Physical Do).

Also, the radio channel control unit 121A outputs information including the selected radio resource, the modulation scheme, the coding rate to the radio channel control information generation unit 133A. The radio channel control unit 121A may perform scheduling so that radio channel control information is transmitted using PDCCH (Physical Downlink Control Channel).

Further, the radio channel control unit 121A outputs the scheduled radio resource, the modulation scheme, the coding rate, etc. to the reception radio unit 111A, the reception orthogonal multiple access processing unit 112A and the demodulation and decoding unit 113A. Further, the radio channel control unit 121A outputs the scheduled radio resource, the modulation scheme, the coding rate, etc. to the transmission power control unit 134A, the coding and modulation unit 135A, the transmission orthogonal multiple access processing unit 136A, and the transmission radio unit 137A.

Further, the radio channel control unit 121A receives the second MBSFN information transmitted from the MCE 300 (or MME 400-C), so as to output the MBSFN ID, the frequency, the slot number, the SFN, etc., which are included in the second MBSFN information, to the radio channel control information generation unit 133A. In this case, for example, the radio channel control unit 121A performs scheduling in such a manner that the above information is transmitted as system information (or system control information) using PDSCH.

The system information management unit 122A manages and stores the system information. As the system information, for example, there are information related to a neighboring base station, an initial value of pilot generation, information related to a random access preamble used when executing a random access procedure, etc.

The notification information generation unit 131A reads out the information related to the neighboring base station etc. from the system information management unit 122A, to generate notification information including the above information. The notification information generation unit 131A outputs the generated notification information to the transmission power control unit 134A.

The pilot generation unit 132A reads out the initial value of a pilot from the system information management unit 122A to generate the pilot, and then outputs the generated pilot to the transmission power control unit 134A.

The radio channel control information generation unit 133A generates radio channel control information including the radio resource, the modulation scheme, the coding rate, etc. which are scheduled in the radio channel control unit 121A. Also, the radio channel control information generation unit 133A generates MBSFN control information (or second MBSFN control information) which includes the MBSFN ID, the frequency, the slot number, the SFN, etc. which are received from the radio channel control unit 121A. For example, the information which is included in the second MBSFN control information, received from the MCE 300, and the information which is included in the MBSFN control information, generated in the radio channel control information generation unit 133A, may be either identical or different. The radio channel control information generation unit 133A outputs the generated radio channel control information and the second MBSFN control information to the transmission power control unit 134A.

The transmission power control unit 134A outputs notification information, pilot, radio channel control information, second MBSFN control information, transmission data, etc., according to a transmission power control value received from the radio channel control unit 121A.

The coding and modulation unit 135A performs an error correction coding processing on the transmission data etc. being output from the transmission power control unit 134A, according to the coding rate received from the radio channel control unit 121A, to add CRC (Cyclic Redundancy Check) on the basis of the coded transmission data.

Also, the coding and modulation unit 135A generates a scrambling code on the basis of the cell ID, the slot number, etc. which are received from the radio channel control unit 121A, to execute a scrambling processing on the transmission data etc. having the added CRC, using the generated scrambling code. Then, the coding and modulation unit 135A executes a modulation processing on the transmission data etc. on which the scrambling processing is performed, according to the modulation scheme received from the radio channel control unit 121A. The coding and modulation unit 135A outputs the modulated transmission data etc. as a transmission signal. The coding and modulation unit 135A is, for example, a generation unit which generates the scrambling code, and also a processing unit which performs the scrambling processing.

Here, the coding and modulation unit 135A does not perform the coding, the addition of CRC, the scrambling processing etc. on the pilot and a synchronous signal.

The transmission orthogonal multiple access processing unit 136A executes an IFFT (Inverse Fast Fourier Transform) processing, a P/S (Parallel to Serial) conversion processing, etc. on the transmission signal being output from the coding and modulation unit 135A, to convert into a signal (for example, an OFDMA signal) which supports multiple access. At that time, the transmission orthogonal multiple access processing unit 136A performs a transmission orthogonal multiple access processing based on the radio resource etc. received from the radio channel control unit 121A. The transmission orthogonal multiple access processing unit 136A outputs the converted transmission signal to the transmission radio unit 137A.

The transmission radio unit 137A executes a frequency conversion processing, an amplification processing, etc. on the transmission signal being output from the transmission orthogonal multiple access processing unit 136A, on the basis of the frequency etc. received from the radio channel control unit 121A, to convert (upconvert) into a radio signal. The transmission radio unit 137A outputs the radio signal to the antenna 101A.

<Configuration Example of Base Station 100-C>

FIG. 9 is a diagram illustrating a configuration example of the base station 100-C. The base station 100-C includes an antenna 101C, a reception unit 110C, a control unit 120C and a transmission unit 130C.

Here, the second transmitter 170-2 in the first embodiment corresponds to the transmission unit 130C, for example. The third transmitter 170-3 in the first embodiment corresponds to the transmission unit 130C also, for example.

The reception unit 110C includes a reception radio unit 111C, a reception orthogonal multiple access processing unit 112C and a demodulation and decoding unit 113C. Also, the control unit 120C includes a radio channel control unit 121C and a system information management and storage unit (which may hereafter be referred to as “system information management unit”) 122C. Further, the transmission unit 130C includes a pilot generation unit (or reference signal generation unit) 132C, an MBSFN control information generation unit 138C, a coding and modulation unit 135C, a transmission orthogonal multiple access processing unit 136C and a transmission radio unit 137C.

In the following description, each function and processing further provided in the base station 100-A will be described.

The demodulation and decoding unit 113C generates a scrambling code on the basis of the MBSFN ID, the slot number, etc. which are received from the radio channel control unit 121C, to perform the descrambling processing on a demodulated reception signal, using the generated scrambling code. The demodulation and decoding unit 113C is also a generation unit which generates the scrambling code, and also a processing unit which performs the descrambling processing, for example.

The radio channel control unit 121C further receives the second MBSFN control information transmitted from the MCE 300, to output the use frequency, the use modulation scheme, the use coding rate, the transmission timing, etc. to the MBSFN control information generation unit 138C. The base station 100-C transmits the above information using MCCH (Multicast Control Channel, or MBMS Control Channel) which is a logical channel. For this purpose, the radio channel control unit 121C may output information, including a radio resource related to MCCH etc., to the transmission orthogonal multiple access processing unit 136C and the transmission radio unit 137C.

Also, the radio channel control unit 121C further receives a data amount of MBMS data transmitted from the MCE 300, and according to the received data amount, selects MBMS data to be distributed among the MBMS data received from the MBMS GW 800. Then, according to the second MBSFN control information scheduled in the MCE 300, the radio channel control unit 121C distributes the MBMS data. For this purpose, the radio channel control unit 121C outputs the MBSFN ID, the use modulation scheme, the use coding rate, the use frequency, the transmission timing, etc. which are included in the second MBSFN control information, to the coding and modulation unit 135C, the transmission orthogonal multiple access processing unit 136C and the transmission radio unit 137C. In this case, the radio channel control unit 121C outputs the use frequency etc. to the transmission orthogonal multiple access processing unit 136C and the transmission radio unit 137C in order that the MBMS data may be transmitted using MTCH (Multicast Traffic Channel) which is a logical channel.

The radio channel control unit 121C may store the second MBSFN control information in the system information management unit 122C.

Further, the pilot generation unit 132C generates a pilot (hereafter, an “MBSFN pilot”) which is mapped to an MBSFN sub-frame. The pilot generation unit 132C generates the MBSFN pilot, which is also a reference signal sequence, using a calculation equation different from a pilot which is mapped to an ordinary sub-frame. The pilot generation unit 132C generates an MBSFN pilot r_{l,ns}(m) using, for example, the following calculation equation.

$$\begin{matrix}[ Equation 1 ] & \\ {r}_{l , {n}_{c}} ( m ) = \frac{1}{\sqrt{2}} ( 1 - 2 \cdot c ( m ) ) + j \frac{2}{\sqrt{2}} ( 1 - 2 \cdot c ( 2 m + 1 ) ) , \\ m = 0 , 1 , … , 6 {N}_{RB}^{max DL} - 1 & ( 1 ) \\ [ Equation 2 ] & \\ {c}_{init} = {2}^{9} \cdot ( 7 \cdot ( {n}_{s} + 1 ) + l + 1 ) \cdot ( 2 \cdot {N}_{ID}^{MBSFN} + 1 ) + {N}_{ID}^{MBSFN} & ( 2 )\end{matrix}$$

Equation (2) represents the initial value of c( ) in equation (1), and N_{ID}^{MBSFN} represents MBSFN ID. The pilot generation unit 132C reads out equation (1), equation (2), the MBSFN ID, etc. stored in the system information management unit 122C, for example, and substitutes the MBSFN ID etc. into equation (1) and equation (2) to generate the MBSFN pilot. The pilot generation unit 132C outputs the generated MBSFN pilot to the coding and modulation unit 135C.

The MBSFN control information generation unit 138C receives from the radio channel control unit 121C information to be included in second MBSFN control information, such as the MBSFN ID, the M-RNTI, the use frequency, the use coding rate, the use modulation scheme, the transmission timing, etc. The MBSFN control information generation unit 138C generates MBSFN control information including the above received information. Hereafter, the above MBSFN control information may be referred to as second MBSFN control information. The MBSFN control information generation unit 138C outputs the generated MBSFN control information to the coding and modulation unit 135C. The information included in the second MBSFN control information generated by the MBSFN control information generation unit 138C may be either identical to or different from the information included the second MBSFN control information which the base station 100-C receives from the MCE 300, for example.

The coding and modulation unit 135C receives the MBMS data transmitted from the MBMS GW 800, receives the pilot from the pilot generation unit 132C, and receives the second MBSFN control information from the MBSFN control information generation unit 138C. Then, the coding and modulation unit 135C executes the error correction coding processing on the MBMS data, the second MBSFN control information, etc. according to the use coding rate received from the radio channel control unit 121C, to add a CRC (Cyclic Redundancy Check) code to the coded MBMS data etc. In this case, the coding and modulation unit 135C executes the scrambling processing on the MBMS data etc. to which the CRC code is added.

The scrambling processing is, for example, as follows. Namely, the coding and modulation unit 135C generates a scrambling code using the MBSFN ID received from the radio channel control unit 121C. For example, the coding and modulation unit 135C generates a scrambling code b^{(q)}(i) using the following equation.

[Equation 3]

\tilde{b}^{(q)}(i)=(b^{(q)}(i)+n c^{(q)}(i))mod2 (3)

[Equation 4]

cᵢₙᵢₜ=└nₛ/2┘·2⁹+N_{ID}^{MBSFN} (4)

Equation (4) represents the initial value of c(q)(i) indicated in equation (3), nₛ represents the slot number, and N_{ID}^{MBSFN} represents the MBSFN ID. For example, the coding and modulation unit 135C holds equation (3) and equation (4) in an internal memory, or the like, and reads out the equations from the internal memory to substitute the MBSFN ID, the slot number, etc. received from the radio channel control unit 121C into the equations to generate a scrambling code. The coding and modulation unit 135C is also a generation unit which generates the scrambling code, and also a processing unit which performs the scrambling processing, for example.

The coding and modulation unit 135C executes the modulation processing on the MBMS data etc. on which the scrambling processing is executed, according to the use modulation scheme received from the radio channel control unit 121C. The coding and modulation unit 135C outputs the modulated MBMS data etc. to the transmission orthogonal multiple access processing unit 136C.

Here, the coding and modulation unit 135C does not perform coding, the addition of CRC, the scrambling processing, etc. on the MBSFN pilot and a synchronous signal.

In the above manner, the base station 100-C transmits the MBMS data according to the second MBSFN control information, using the unlicensed band.

<Regarding MBMS Data Transmission Channel>

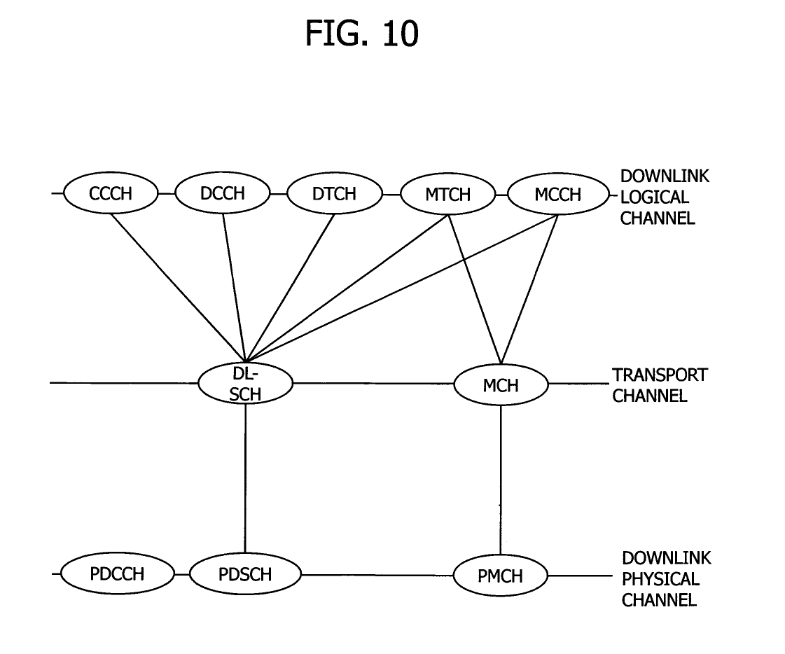

Now, a description will be given on the transmission channel of MBMS data. FIG. 10 is a diagram illustrating a relation example among a logical channel, a transport channel and a physical channel in the downlink direction.

As mentioned above, the base station 100-C transmits the MBMS data using MTCH, which is a logical channel, and also transmits the second MBSFN control information using MCCH which is a logical channel.

MTCH and MCCH are mapped (or arranged) to MCH (Multicast Channel) which is a transport channel. In this case, MTCH and MCCH may be mapped to DL-SCH (Down Link Shared Channel).

MCH is mapped to PMCH (Physical Multicast Channel). The use of PMCH enables the base station 100 to transmit the MBMS data and the second MBSFN control information in broadcast.

The above-mentioned MBSFN pilot is mapped to PMCH and transmitted. The MBSFN pilot is a reference signal sequence which is calculated using a calculation equation different from the reference signal mapped to an ordinary sub-frame, and a layout in the sub-frame is also different. The MBSFN pilot may be referred to as MBSFN RS (MBSFN reference signal).

Here, the base station 100-A may transmit the first MBSFN control information using DCCH (Dedicated Control Channel) or DTCH (Dedicated Traffic Channel) which are logical channels. Additionally, among downlink logical channels, CCCH (Common Control Channel) is a logical channel which is used when not having an RRC connection.

CCCH, DCCH and DTCH are mapped to DL-SCH, a transport channel. Also, DL-SCH of the transport channel is mapped to PDSCH which is a downlink physical channel. The base station 100-A can transmit the first MBSFN control information using PDSCH.

Additionally, in the MBSFN transmission, there is used an MBSFN frame format which is different from a frame format used in the shared channel (DSCH: Downlink Shared Channel) through which the ordinary data of an individual user (or a terminal) is transmitted. As to the MBSFN frame format, for example, refer to 3GPP TS 36.211 V10.7.0 (2013-2) Chapter 6.10.2 etc.

<Terminal Configuration Example>

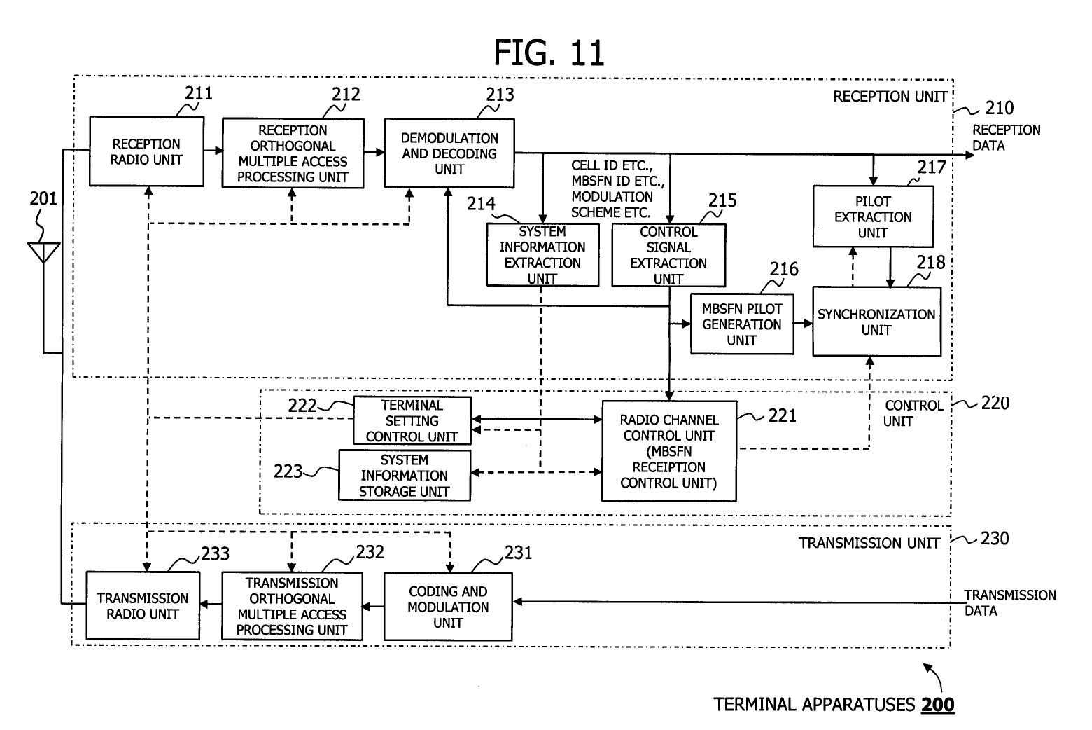

FIG. 11 is a diagram illustrating a configuration example of the terminal 200. The terminal 200 includes an antenna 201, a reception unit 210, a control unit 220 and a transmission unit 230.

Here, the receiver unit 270 in the first embodiment corresponds to the reception unit 210, for example.

The reception unit 210 includes a reception radio unit 211, a reception orthogonal multiple access processing unit 212, a demodulation and decoding unit 213, a system information extraction unit 214, a control signal extraction unit 215, an MBSFN pilot generation unit 216, a pilot extraction unit 217 and a synchronous unit 218.

Also, the control unit 220 includes a radio channel control unit (or MBSFN reception control unit) 221, a terminal setting control unit 222 and a system information storage unit 223.

Further, the transmission unit 230 includes a coding and modulation unit 231, a transmission orthogonal multiple access processing unit 232 and a transmission radio unit 233.

The antenna 201 receives a radio signal transmitted from the base station 100, and outputs the received radio signal to the reception radio unit 211. Also, the antenna 201 receives a radio signal being output from the transmission radio unit 233, and transmits the received radio signal to the base station 100.

The reception radio unit 211 executes the amplification processing, the frequency conversion processing, etc. on the radio signal, on the basis of a frequency etc. received from the terminal setting control unit 222, to convert (downconvert) into a baseband signal in the baseband. The reception radio unit 211 outputs the baseband signal to the reception orthogonal multiple access processing unit 212.

The reception orthogonal multiple access processing unit 212 executes an A/D conversion processing, a S/P conversion processing, a FFT processing, etc. on the baseband signal to demultiplex a multiplexed signal. In this case, according to a radio resource received from the terminal setting control unit 222, the reception orthogonal multiple access processing unit 212 performs a reception orthogonal multiple access processing to demultiplex the signal. The reception orthogonal multiple access processing unit 212 outputs the demultiplexed reception signal to the demodulation and decoding unit 213.

The demodulation and decoding unit 213 executes the demodulation processing and the error correction decoding processing on the reception signal, according to the modulation scheme and the coding rate received from the terminal setting control unit 222. Also, the demodulation and decoding unit 213 executes the descrambling processing on the demodulated reception signal. At that time, the demodulation and decoding unit 213 generates a scrambling code on the basis of a cell ID (or MBSFN ID) and a slot number to perform the descrambling processing using the scrambling code. The demodulation and decoding unit 213 then determines by CRC whether or not there is an error in the descrambled reception signal, and separates the CRC to reproduce reception data etc.

If the reception data is MBMS data, the demodulation and decoding unit 213, based on the MBSFN ID and the slot number received from the control signal extraction unit 215, generates a scrambling code using equation (3) and equation (4) to perform descrambling, for example. The demodulation and decoding unit 213 may hold calculation equations, such as equation (3) and equation (4), for the generation of the scrambling code in an internal memory, for example, or may read out from the internal memory at a processing to generate the scrambling code. The demodulation and decoding unit 213 is also a generation unit which generates the scrambling code, and also a processing unit which performs the descrambling processing, for example.

The terminal 200 generates the scrambling code on the basis of the MBSFN ID included in the first MBSFN control information, and the base station 100-C also generates a scrambling code on the basis of the MBSFN ID included in the second MBSFN control information. Accordingly, the terminal 200 generates the scrambling code which is identical to the scrambling code generated in the base station 100-C, which performs the MBSFN transmission, on the basis of the identical (or common) MBSFN ID. Therefore, using the generated scrambling code, the terminal 200 performs the descrambling processing on data which is scrambling processed and received from the base station 100-C, so that can extract the data.

Here, although the terminal 200 also receives a pilot and a synchronous signal, for example, in the demodulation and decoding unit 213 etc., it is configured to perform a reception processing on the pilot and the synchronous signal, without the error correction decoding processing, CRC separation and the scrambling processing.

The system information extraction unit 214 extracts system information from data being output from the demodulation and decoding unit 213, etc. The system information includes the first MBSFN control information, for example. The system information extraction unit 214 outputs the extracted system information to the radio channel control unit 221, the terminal setting control unit 222 and the system information storage unit 223. This enables the system information extraction unit 214 to output an MBSFN ID included in first MBSFN control information, a frequency, a slot number, an SFN, etc. to be used in the base station 100-C, to the radio channel control unit 221 and the terminal setting control unit 222.

The control signal extraction unit 215 extracts a control signal (or radio channel control information or second MBSFN control information) from data etc. being output from the demodulation and decoding unit 213. The control signal extraction unit 215 outputs the MBSFN ID, the use frequency, the use modulation scheme, the use coding rate, the transmission timing, the MBSFN ID, etc. which are included in the extracted second MBSFN control information to the demodulation and decoding unit 213, the MBSFN pilot generation unit 216 and the radio channel control unit 221.

The MBSFN pilot generation unit 216 generates an MBSFN pilot on the basis of the MBSFN ID etc. among the second MBSFN control information being output from the control signal extraction unit 215. For example, the MBSFN pilot generation unit 216 may generate using the aforementioned equation (1) and equation (2). These equations are held in the internal memory etc. of the MBSFN pilot generation unit 216, for example, so that the MBSFN pilot generation unit 216 may appropriately read out to perform a processing. The MBSFN pilot generation unit 216 outputs the generated pilot to the synchronous unit 218.

The pilot extraction unit 217 extracts the MBSFN pilot and the ordinary pilot from the data etc. being output from the demodulation and decoding unit 213. The pilot extraction unit 217 outputs the extracted MBSFN pilot and the ordinary pilot to the synchronous unit 218.

The synchronous unit 218 generates, based on the ordinary pilot, a synchronous signal to be used in the inside of the terminal 200, for example. The radio channel control unit 221 refers to the generated synchronous signal to synchronize each unit in the terminal 200, so as to enable the terminal 200 to perform radio communication in synchronization with the base station 100-A.

Further, the synchronous unit 218 generates a synchronous signal to be used in the inside of the terminal 200, for example, on the basis of the MBSFN pilot received from the MBSFN pilot generation unit 216 and the MBSFN pilot received from the pilot extraction unit 217. The radio channel control unit 221 refers to the generated synchronous signal to synchronize each unit in the terminal 200, so as to enable the terminal 200 to perform radio communication in synchronization with the base station 100-C.

The radio channel control unit 221, on receiving the first MBSFN control information from the system information extraction unit 214, for example, outputs the first MBSFN control information to the terminal setting control unit 222. At this time, the radio channel control unit 221 instructs the terminal setting control unit 222 so that the terminal 200 performs the reception processing and a transmission processing between with the base station 100-C on the basis of the MBSFN ID, the frequency, the slot number, etc. included in the first MBSFN control information.

Also, on receiving the second MBSFN control information from the control signal extraction unit 215, for example, the radio channel control unit 221 outputs the second MBSFN control information to the terminal setting control unit 222. At this time, the radio channel control unit 221 instructs the terminal setting control unit 222 so that the terminal 200 performs the reception processing and transmission processing between with the base station 100-C on the basis of the MBSFN ID, the use frequency, the use modulation scheme, etc. included in the second MBSFN control information.

Further, the radio channel control unit 221 receives from the synchronous unit 218 the pilot (MBSFN pilot or ordinary pilot) extracted in the pilot extraction unit 217, for example, and based on the pilot, measures and calculates the reception quality of the radio signal transmitted from the base station 100-C. The radio channel control unit 221 is also a reception quality measurement unit which measures and calculates the reception quality.

Further, for example, the radio channel control unit 221 receives from the synchronous unit 218 the pilot extracted in the pilot extraction unit 217, and based on the pilot, measures and calculates the reception quality of the radio signal transmitted from the base station 100-A.

The terminal setting control unit 222, on receiving the instruction from the radio channel control unit 221, outputs the MBSFN ID, the frequency, etc. which are included in the first MBSFN control information, to the reception radio unit 211, the reception orthogonal multiple access processing unit 212 and the demodulation and decoding unit 213, for example. This enables the terminal 200 to connect and radio communicate with the base station 100-C.

Also, on receiving the instruction from the radio channel control unit 221, the terminal setting control unit 222 outputs the MBSFN ID, the frequency, etc. which are included in the second MBSFN control information, to the reception radio unit 211, the reception orthogonal multiple access processing unit 212 and the demodulation and decoding unit 213, for example. This enables the terminal 200 to receive the MBMS data which is scheduled by the MCE 300 and transmitted from the base station 100-C.

Additionally, the terminal 200 can also receive the radio resource, the modulation scheme, and the coding rate scheduled in the base station 100-A, as the control signal. In this case, the control signal extraction unit 215 extracts the above control signal, and the radio channel control unit 221 outputs the radio resource etc. included in the control signal to the terminal setting control unit 222, so as to instruct the terminal setting control unit 222 to perform the reception processing and transmission processing using the radio resource etc. This enables the terminal setting control unit 222 to output the radio resource etc. to the reception radio unit 211, the reception orthogonal multiple access processing unit 212, the demodulation and decoding unit 213, etc., so that the terminal 200 can receive data etc. transmitted from the base station 100-A.

Here, the terminal setting control unit 222 outputs information included in the first and second MBSFN control information to the transmission radio unit 233, the transmission orthogonal multiple access processing unit 232 and the coding and modulation unit 231, to enable the terminal 200 to perform radio communication with the base stations 100-A, 100-C in the uplink direction also.

The system information storage unit 223 stores the system information received from the system information extraction unit 214.

The coding and modulation unit 231 performs the error correction coding processing and modulation processing on the transmission data, according to the coding rate and the modulation scheme received from the terminal setting control unit 222. The coding and modulation unit 231 receives the cell ID, the MBSFN ID from the terminal setting control unit 222 to generate a scrambling code, so as to execute the scrambling processing on the coded data using the generated scrambling code. The coding and modulation unit 231 outputs the modulated data etc. to the transmission orthogonal multiple access processing unit 232.

It may also be possible for the coding and modulation unit 231 to receive the MBSFN ID, the slot number, etc. from the terminal setting control unit 222 to generate a scrambling code and execute the scrambling processing on the coded data using the generated scrambling code.

The transmission orthogonal multiple access processing unit 232 executes an IFFT processing, a P/S processing, etc. on the coded data being output from the coding and modulation unit 231, to convert into a signal (for example, an OFDMA signal) associated with the multiple access. At that time, the transmission orthogonal multiple access processing unit 232 performs the transmission orthogonal multiple access processing on the basis of the radio resource etc. received from the terminal setting control unit 222. The transmission orthogonal multiple access processing unit 232 outputs the converted transmission signal to the transmission radio unit 233.

The transmission radio unit 233 performs the frequency conversion processing, the amplification processing, etc. on the transmission signal, output from the transmission orthogonal multiple access processing unit 232, on the basis of the frequency etc. received from the terminal setting control unit 222, to convert (upconvert) into a radio signal. The transmission radio unit 233 outputs the radio signal to the antenna 201.

<Operation Example>

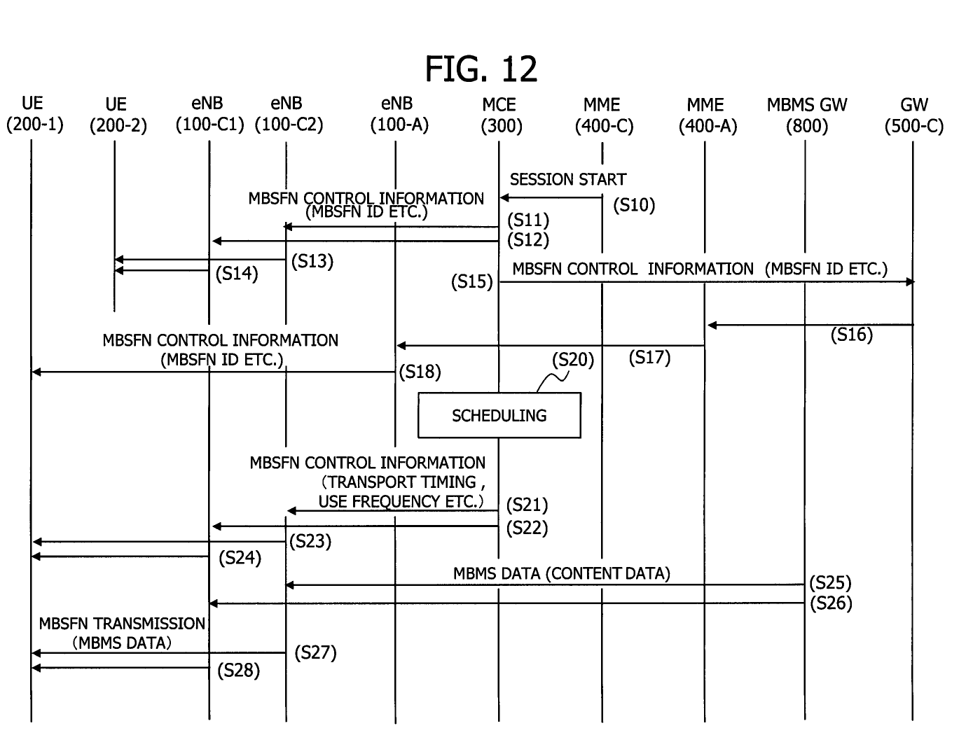

Next, a description will be given on an operation example in the second embodiment. FIG. 12 is a flowchart illustrating the operation example. In the example of FIG. 2 etc., the plurality of base stations 100-C1, . . . , 100-Cn are arranged in subordination to the MCE 300. In the example of FIG. 12, two base stations (eNB) 100-C1, 100-C2 are exemplified in a representative manner. Further, the terminal (UE: User Equipment) 200-2 is assumed to be located out of the cell range of the base station 100-A, whereas located in the MBSFN area of the plurality of base stations 100-C1, 100-C2. Further, the terminal 200-1 is assumed to be located in the cell range of the base station 100-A, and also located in the MBSFN area.

The MME 400-C transmits the control signal which indicates the start of a session for MBMS data to the MCE 300 (S10).

Next, the MCE 300, on receiving the control signal, transmits first MBSFN control information to the subordinate base stations 100-C1, 100-C2 (S11, S12).

Next, each base station 100-C1, 100-C2 transmits the first MBSFN control information in broadcast, using an unlicensed band. (S13, S14). The terminal 200-2 receives the first MBSFN control information.

After transmitting the first MBSFN control information to the subordinate base stations 100-C1, 100-C2 (S11, S12), the MCE 300 transmits the first MBSFN control information to the base station of each operator (S15). In the example of FIG. 12, the first MBSFN control information is transmitted to the base station 100-A of the operator A through the MME 400-C, the GW 500, the network of operator A 600-A and the MME 400-A.

The base station 100-A, on receiving the first MBSFN control information, transmits the received first MBSFN control information to the terminal 200-1 (S18). In this case, the base station 100-A transmits the first MBSFN control information, using a licensed band allocated to the operator A. The terminal 200-1 receives the first MBSFN control information using the licensed band. This enables the connection of the terminal 200-1 to the plurality of base stations 100-C1, 100-C2.

Meanwhile, the MCE 300, after transmitting the first MBSFN control information (S15), schedules the MBMS data (S20). By the scheduling, the MCE 300 generates second MBSFN control information, and transmits the generated second MBSFN control information to the subordinate base stations 100-C1, 100-C2 (S21, S22).

Next, each base station 100-C1, 100-C2 transmits the second MBSFN control information in broadcast, using an unlicensed band (S23, S24). The terminal 200-1, which is in a state capable of receiving the second MBSFN control information on the basis of the first MBSFN control information, receives the second MBSFN control information transmitted in broadcast, on the basis of the first MBSFN control information.

Next, the MBMS GW 800 transmits the MBMS data to the base station 100-C1, 100-C2 (S25, S26), so that the base station 100-C1, 100-C2 transmits the received MBMS data in broadcast using an unlicensed band (S27, S28). The terminal 200-1 receives the MBMS data on the basis of the second MBSFN control information.

As such, in the present second embodiment, the terminal 200-1, which a user contracting with the operator A uses, receives the first MBSFN control information from the base station 100-A of the operator A. Based on the first MBSFN control information, the terminal 200-1 is connected to the base station 100-C which is performing MBSFN transmission using the unlicensed band, so as to receive the second MBSFN control information from the base station 100-C. Based on the second MBSFN control information, the terminal 200-1 can receive the MBMS data which is transmitted using the unlicensed band.

For example, the base station 100-C performs the MBSFN transmission using the unlicensed band, so that can execute the MBSFN transmission using a radio resource shared by each operator. Thus, in comparison with a case when the MBSFN transmission is performed using each licensed band individually allocated to each operator, a wasted radio resource can be saved at the execution of the MBSFN transmission, so that efficient radio resource utilization can be attained in the radio communication system 10.

Also, the terminal 200-1, if contracting with and subscribing to the operator A, can be connected to the base station 100-C, which executes the MBSFN transmission, to receive the MBMS data using the unlicensed band. In the above-mentioned embodiment, the example of such the terminal 200-1 is described. However, as depicted in FIG. 2 for example, the terminal 200-2, which is used by a user contracting with the operator B, can be connected to the base station 100-C to receive MBMS data, also. In this case, the terminal 200-2 receives first MBSFN control information from the base station 100-B which is operated by the operator B. This enables the connection of the terminal 200-2 to the base station 100-C to receive second MBSFN control information from the base station 100-C, on the basis of the first MBSFN control information in a similar manner to the terminal 200-1, so that the terminal 200-2 can receive MBMS data by the reception of the second MBSFN control information. Accordingly, each the terminal 200-1, 200-2, if subscribing to each specific operator, can receive a content (MBMS data) from the base station 100-C which executes the MBSFN transmission using the unlicensed band.

Further, the terminal 200-1 subscribing to the operator A, after being connected to the base station 100-A which is operated by the operator A, is connected to the base station 100-C which performs MBSFN transmission using the unlicensed band. Therefore, it is also possible for the operator A to charge the terminal 200-1 which receives the MBMS data through the base station 100-A. For example, in regard to the terminal 200-1 used by a user having paid a predetermined fee, it may also be possible for the operator A to transmit the first MBSFN control information from the base station 100-A to the terminal 200-1, if confirmation and authentication are successfully made during the connection to the base station 100-A.

For example, there is a case like the Olympics in which people all over the world gather to one site including a stadium, a press center, etc. Such people, if they carry subscriber terminals which contracts with operators in their countries to such a venue, can view contents using the subscriber terminals, according to the above-mentioned embodiment.

### Third Embodiment

Next, a description will be given on a third embodiment. The present third embodiment is an example of system frame number (SFN) notification.

A radio frame number (or system frame number), a sub-frame number and a slot number of one operator at a certain moment are not always coincident with a radio frame number, a sub-frame number and a slot number of another operator, respectively. The reason is that the radio frame number, the sub-frame number and the slot number are independently set by each operator, for example.

The sub-frame and the slot in which a synchronous signal is transmitted in a radio frame are specified in the 3GPP etc. Therefore, by receiving the synchronous signal, the terminal 200-1 can recognize the sub-frame number and the slot number. However, it is not possible for the terminal 200-1 to recognize the system frame number if receiving the synchronous signal.

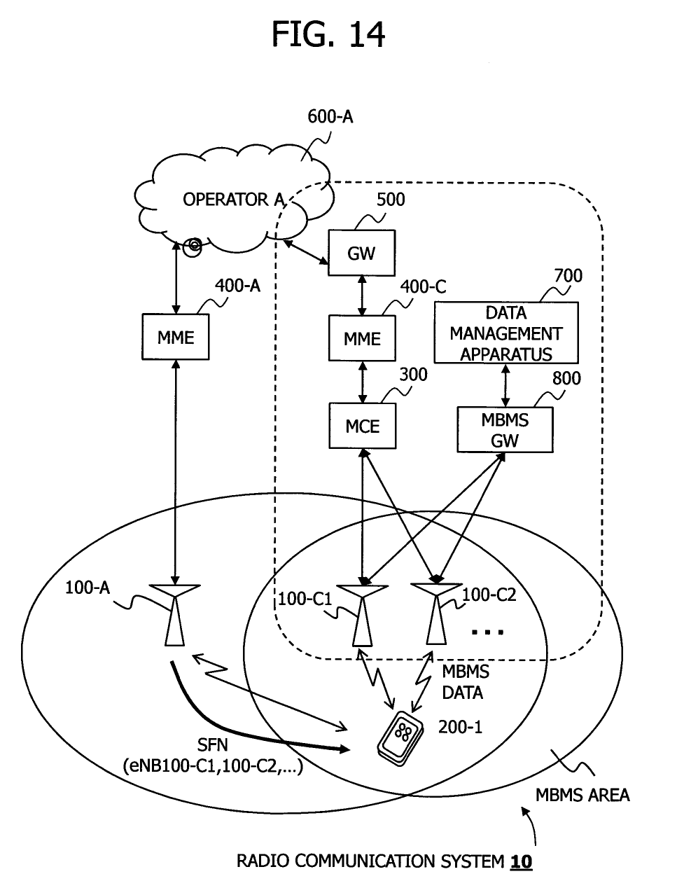

FIG. 14 illustrates a configuration example of the radio communication system 10 in the present third embodiment. In the present third embodiment, the base station 100-A transmits to the terminal 200-1 the system frame number when the MBSFN transmission is performed, as well as the MBSFN ID. It may also be possible for the base station 100-A to transmit the system frame number by including in the first MBSFN control information. This enables the terminal 200-1 to recognize the system frame number when the MBSFN transmission is performed, and receive MBMS data in synchronization with the base stations 100-C1, 100-C2, for example.

For example, the system frame number is generated in the MCE 300 and the MME 400-C and transmitted to the base station (base station 100-A etc.) of each operator through the GW 500, similar to the MBSFN ID. Or, it may also be possible to transmit the system frame number in broadcast, before the plurality of base stations 100-C1, 100-C2 perform the MBSFN transmission. For example, the system frame number may be included in the second MBSFN control information.

### Other Embodiments

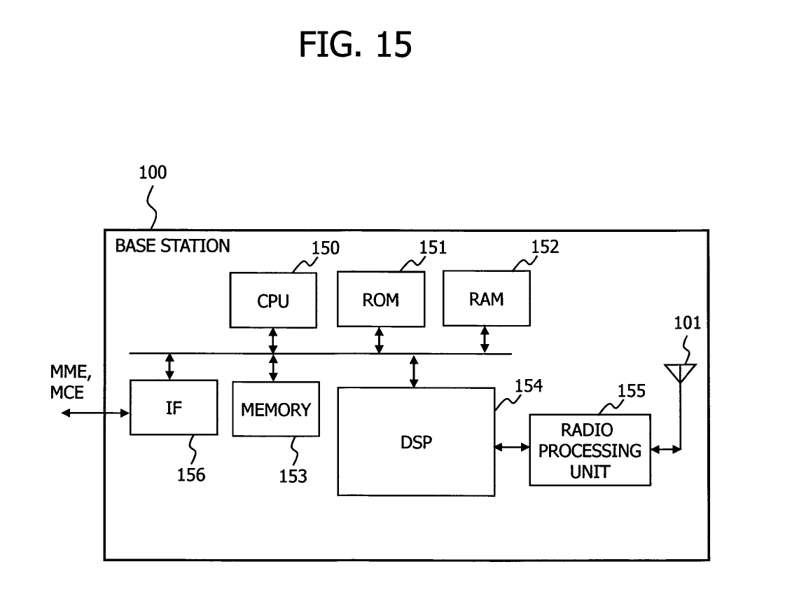

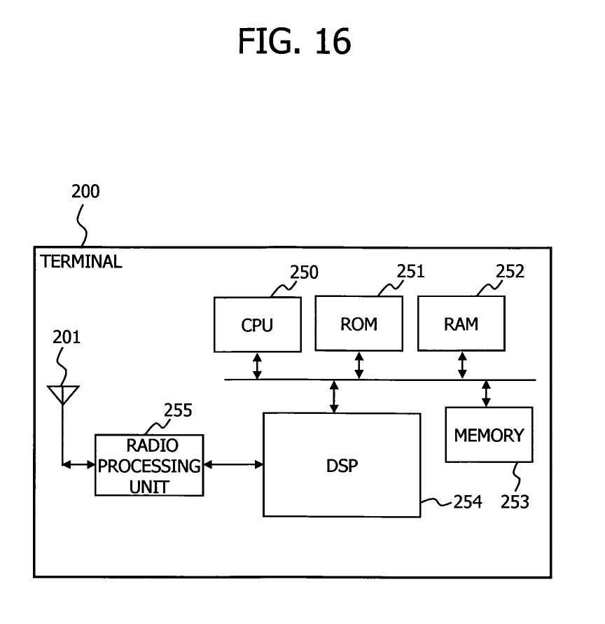

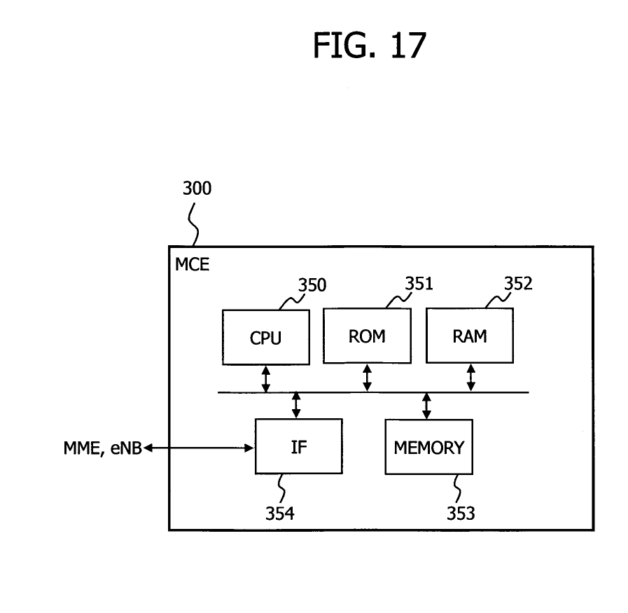

Other embodiments will be described. FIG. 15 is a diagram illustrating a hardware configuration example of a base station 100, FIG. 16 is that of the terminal 200 and FIG. 17 is that of the MCE 300.

As depicted in FIG. 15, the base station 100 includes an antenna 101, a CPU (Central Processing Unit) 150, a ROM (Read Only Memory) 151, a RAM (Random Access Memory) 152, a memory 153, a DSP (Digital Signal Processor) 154, a radio processing unit 155 and an IF (Interface) 156.

The CPU 150 reads out each program stored in the ROM 151 to load on the RAM 152, and executes the loaded program to execute the functions of the radio channel quality information extraction unit 114A, the transmission power information extraction unit 115A, the radio channel control unit 121A, the notification information generation unit 131A, the pilot generation unit 132A, the radio channel control information generation unit 133A and the transmission power control unit 134A. Therefore, the CPU 150 corresponds to the radio channel quality information extraction unit 114A, the transmission power information extraction unit 115A, the radio channel control unit 121A, the notification information generation unit 131A, the pilot generation unit 132A, the radio channel control information generation unit 133A and the transmission power control unit 134A in the second embodiment, for example.

Further, the CPU 150 executes each program loaded on the RAM 152, to thereby execute the functions of the radio channel control unit 121C, the pilot generation unit 132C and the MBSFN control information generation unit 138C. Therefore, the CPU 150 corresponds to the radio channel control unit 121C, the pilot generation unit 132C and the MBSFN control information generation unit 138C in the second embodiment, for example.

The DSP 154 executes, according to each instruction from the CPU 150, the functions of the reception orthogonal multiple access processing unit 112A, the demodulation and decoding unit 113A, the coding and modulation unit 135A and the transmission orthogonal multiple access processing unit 136A. Therefore, the DSP 154 corresponds to the reception orthogonal multiple access processing unit 112A, the demodulation and decoding unit 113A, the coding and modulation unit 135A and the transmission orthogonal multiple access processing unit 136A in the second embodiment, for example.

Also, according to each instruction from the CPU 150, the DSP 154 executes the functions of the reception orthogonal multiple access processing unit 112C, the demodulation and decoding unit 113C, the coding and modulation unit 135C and the transmission orthogonal multiple access processing unit 136C. Therefore, the DSP 154 corresponds to the reception orthogonal multiple access processing unit 112C, the demodulation and decoding unit 113C, the coding and modulation unit 135C and the transmission orthogonal multiple access processing unit 136C in the second embodiment, for example.

Further, the memory 153 corresponds to the system information management units 122A, 122C in the second embodiment, for example. Also, the radio processing unit 155 corresponds to the reception radio units 111A, 111C, and the transmission radio units 137A, 137C in the second embodiment, for example.

The IF 156 is an interface to connect the base station 100 to other apparatuses (the MME 400-A, the MCE 300, etc.), so as to convert data, received from the CPU 150 etc., into a format transmittable to the other apparatuses and transmit. Also, the IF 156 extracts exact data etc. from the data of a predetermined format, which is transmitted from other apparatuses, to output to the memory 153 and the CPU 150.

As depicted in FIG. 16, the terminal 200 includes a CPU 250, a ROM 251, a RAM 252, a memory 253, a DSP 254, a radio processing unit 255 and the antenna 201.

The CPU 250 reads out each program stored in the ROM 251 to load on the RAM 252, and executes the loaded program to execute the functions of the system information extraction unit 214, the control signal extraction unit 215, the MBSFN pilot generation unit 216, the pilot extraction unit 217, the synchronous unit 218, the radio channel control unit 221 and the terminal setting control unit 222. The CPU 250 corresponds to the system information extraction unit 214, the control signal extraction unit 215, the pilot extraction unit 217, the synchronous unit 218, the radio channel control unit 221, the terminal setting control unit 222 and the system information storage unit 223 in the second embodiment, for example.

The DSP 254 executes, according to each instruction from the CPU 150, the functions of the reception orthogonal multiple access processing unit 212, the demodulation and decoding unit 213, the coding and modulation unit 231 and the transmission orthogonal multiple access processing unit 232. Therefore, the DSP 254 corresponds to the reception orthogonal multiple access processing unit 212, the demodulation and decoding unit 213, the coding and modulation unit 231 and the transmission orthogonal multiple access processing unit 232 in the second embodiment, for example.

The memory 253 corresponds to the system information storage unit 223 in the second embodiment, for example. Also, the radio processing unit 255 corresponds to the reception radio unit 211 and the transmission radio unit 233 in the second embodiment, for example.

As depicted in FIG. 17, the MCE 300 includes a CPU 350, a ROM 351, a RAM 352, a memory 353 and an IF 354.

The CPU 350 reads out each program stored in the ROM 351 to load on the RAM 352, and executes the loaded program to execute the functions of the session control unit 310, the scheduler 320 and the content control unit 330. Therefore, the CPU 350 corresponds to the session control unit 310, the scheduler 320 and the content control unit 330, for example.

The memory 353 may store the session control information, the content control information, the first and second MBSFN control information, etc., for example. The IF 354 converts information etc., received from the CPU 350 etc., into the data of a format transmittable to external apparatuses (for example, the MME 400-C, the base station 100-C) to transmit thereto. Also, the IF 354 receives the data of a predetermined format transmitted from the external apparatuses to extract information etc. from the data to output to the memory 353 and the CPU 350.

Here, each the CPU 150, 250, 350 may be a controller such as an MPU (Micro Processing Unit), an FPGA (Field Programmable Gate Array), etc.

In the aforementioned embodiments, the first MBSFN control information may be generated in the MCE 300 or may be generated in the MME 400-C. As mentioned above, a part of information included in the first MBSFN control information may be generated in the MCE 300, whereas other information may be generated in the MME 400-C.

Further, in the aforementioned embodiments, as to the use frequency included in the second MBSFN control information, the description has been given on the example that the base station 100-C transmits the MBMS data using the use frequency without any change, for example. For example, the base station 100-C may transmit the MBMS data using a frequency, which is different from the use frequency, obtained through a predetermined algorithm and an equation. As a parameter used in such an algorithm and an equation, for example, information included in the second MBSFN control information may be used. For example, the radio channel control unit 121C in the base station 100-C and the radio channel control unit 221 in the terminal 200 may calculate the different frequency using the algorithm and the equation, so that may control the transmission radio unit 137C, the reception radio unit 211, etc.

Further, in the aforementioned embodiment, the description has been given such that the information included in the first MBSFN control information is different from the information included in the second MBSFN control information, for example. The information included in the first MBSFN control information may be identical to the information included in the second MBSFN control information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

### REFERENCE SIGNS LIST

10: Radio communication system

100-A, 100-B, 100-C1, . . . , 100-Cn: Base station apparatus

110A, 110C: Reception unit

101A, 101C: Antenna

113A, 113C: Demodulation and decoding unit

120A, 120C: Control unit

121A, 121C: Radio channel control unit

122A, 122C: System information management and storage unit

130A, 130C: Transmission unit

132A, 132C: Pilot generation unit

135A, 135C: Coding and modulation unit

138C: MBSFN control information generation unit

150: CPU

200, 200-1, 200-2: Terminal apparatus

201: Antenna

210: Reception unit

213: Demodulation and decoding unit

214: System information extraction unit

215: Control signal extraction unit

216: MBSFN pilot generation unit

217: Pilot extraction unit

220: Control unit

221: Radio channel control unit

222: Terminal setting control unit

223: System information storage unit

230: Transmission unit

250: CPU

300: MCE

320: Scheduler

350: CPU

400-A, 400-B, 400-C: MME

450-A: SGW

460-A: PGW

500: GW

600-A: A network of an operator A

600-B: A network of an operator B

700: Data management apparatus

800: MBMS GW

What is claimed is;:

1. A radio communication system comprising:
a first base station apparatus which is capable of performing radio communication by using a first frequency band requiring license;
a second base station apparatus;
a radio channel control apparatus; and
a terminal apparatus, wherein
the radio channel control apparatus includes:
a scheduler configured to transmit a first control information including a second frequency in a second frequency band without requiring the license and a first transmission timing to the second base station apparatus,
the second base station apparatus includes:
a second transmitter configured to transmit data common to the terminal apparatus by using the second frequency at the first transmission timing,
the first base station apparatus includes:
a first transmitter configured to transmit the first control information by using the first frequency to the terminal apparatus, and
the terminal apparatus includes:
a receiver configured to receive the first control information transmitted from the first base station apparatus by using the first frequency, and receive the data common to the terminal apparatus transmitted from the second base station apparatus by using the second frequency at the first transmission timing.

2. The radio communication system according to claim 1, wherein
the receiver is configured to receive the first control information and the data common to the terminal apparatus transmitted from the second base station apparatus.

3. The radio communication system according to claim 1, wherein
the first transmitter configured to transmit the first control information including identification information identified an area where the data common to the terminal apparatus is transmitted by using the second frequency at the first transmission timing, or identification information identified a service common to the terminal apparatus provided in the area.

4. The radio communication system according to claim 3, wherein
the scheduler is configured to transmit the first control information including the identification information to the second base station apparatus,
the second base station apparatus includes:
a first generator configured to generate a first scrambling code by the identification information, and
a first scrambling processor configured to perform a scrambling processing to the data common to the terminal apparatus by using the first scrambling code,
the second transmitter is configured to transmit the scrambling processed data common to the terminal apparatus, and
the terminal apparatus includes:
a third generator configured to generate the first scrambling code by the identification information included in the first control information, and
a descrambling processor configured to perform a descrambling processing to the scrambling processed data common to the terminal apparatus received by the receiver by using the first scrambling code generated by the third generator, and extract the data common to the terminal apparatus.

5. The radio communication system according to claim 3, wherein
the second base station apparatus includes:
a first reference signal generator configured to generate a reference signal of the identification information included in the first control information,
the second transmitter is configured to transmit the reference signal,
the receiver is configured to receive the reference signal, and
the terminal apparatus includes:
a reception quality measurer configured to measure and calculate reception quality from the reference signal.

6. The radio communication system according to claim 3, wherein
the first transmitter is configured to transmit the first control information including the identification information and a third frequency in the second frequency band.

7. The radio communication system according to claim 6, wherein
the first transmitter is configured to transmit the first control information including a slot number.

8. The radio communication system according to claim 6, wherein
the first transmitter is configured to transmit the first control information including a system frame number.

9. The radio communication system according to claim 1, wherein
the scheduler is configured to transmit the first control information including a first modulation scheme and a first coding rate to the second base station apparatuses,
the second transmitter is configured to perform an error correction coding processing by the first coding rate and a modulation processing to the error correction coding processed data common to the terminal apparatus by the first modulation scheme, from the first control information, and transmit the modulation processed data common to the terminal apparatus by using the second frequency at the first transmission timing.

10. The radio communication system according to claim 6, wherein
the receiver is configured to receive the data common to the terminal apparatus transmitted from the second base station apparatus by using the second frequency at the first transmission timing, and perform a demodulation processing to the received data common to the terminal apparatus by the first modulation scheme and an error correction decoding processing to the demodulated data common to the terminal apparatus by the first coding rate.

11. The radio communication system according to claim 2, wherein
the second transmitter is configured to transmit the first control information by using the second frequency at a second transmission timing.

12. A base station apparatus capable of performing radio communication by using a first frequency band requiring license, the apparatus comprising:
a receiver configured to receive a first control information to connect to any one of another base station apparatus out of a plurality of the other base station apparatuses transmitting data common to a terminal apparatus by using a second frequency without requiring the license at a first transmission timing; and
a transmitter configured to transmit the first control information to the terminal apparatus by using a first frequency in the first frequency band, wherein
the terminal apparatus connects to the other base station apparatus from the first control information and receives the data common to the terminal apparatus transmitted from the other base station apparatus by using the second frequency at the first transmission timing.

13. A terminal apparatus comprising:
a receiver configured to receive a first control information transmitted from a first base station apparatus capable of performing radio communication by using a first frequency band requiring license by using a first frequency in the first frequency band; and
a controller configured to connect to a second base station apparatus transmitting data common to a terminal apparatus by using a second frequency in a second frequency band without requiring the license at a first transmission timing, wherein
the receiver is configured to receive the data common to the terminal transmitted from the second base station apparatus by using the second frequency at the first transmission timing.
